(19) United States
(12) Patent Application Publication
(10) Pub. No.: US 2013/0063576 A1
(43) Pub. Date: Mar. 14, 2013

(54) STEREOSCOPIC INTENSITY ADJUSTMENT DEVICE, STEREOSCOPIC INTENSITY ADJUSTMENT METHOD, PROGRAM, INTEGRATED CIRCUIT AND RECORDING MEDIUM

(71) Applicants: Masafumi Okubo, Kyoto (JP); Osamu Yamaji, Osaka (JP)

(72) Inventors: Masafumi Okubo, Kyoto (JP); Osamu Yamaji, Osaka (JP)

(73) Assignee: PANASONIC CORPORATION, Osaka (JP)

(21) Appl. No.: 13/642,008

(22) PCT Filed: Apr. 24, 2012
(86) PCT No.: PCT/JP2012/002786

§ 371 Date: Oct. 18, 2012

(30) Foreign Application Priority Data
Apr. 28, 2011 (JP) 2011-101419

(51) Int. Cl. H04N 13/04

(52) U.S. Cl. 348/51; 348/E13.075

(57) ABSTRACT

A parallax map acquisition unit acquires a parallax map indicating a parallax value for each pixel in a set of main-view data and sub-view data constituting stereoscopic video images. A parallax map assessment unit assesses the accuracy of the acquired parallax map. A stereoscopic intensity adjustment method selection unit selects either pixel shifting by a DIBR execution unit using the parallax map or plane shifting by a plane shift execution unit. The DIBR execution unit and the plane shift execution unit adjust stereoscopic intensity in accordance with the selection of the stereoscopic intensity adjustment method by the stereoscopic intensity adjustment method selection unit.

### TECHNICAL FIELD

The present invention relates to technology for adjusting the stereoscopic intensity of stereoscopic video images.

### BACKGROUND ART

In recent years, technology for playing back stereoscopic video images using binocular parallax has been gaining attention. Human perception of three dimensions is based on differences between images entering the left and the right eye (for example, see Non-Patent Literature 1). A viewer can therefore be caused to perceive depth by independently being shown left and right images having parallax therebetween (a left-view video image and a right-view video image). Patent Literature 1, for example, discloses conventional technology relating to household playback devices. Patent Literature 2, for example, discloses conventional technology relating to stereoscopic playback. Stereoscopic video images may be viewed using such technologies.

Viewers often have different preferences as to the amount by which stereoscopic video images project or recede. The amount by which stereoscopic video images project or recede also depends on the size of the display showing the stereoscopic video images. The stereoscopic intensity of stereoscopic video images is therefore adjusted using the technology disclosed in Patent Literature 3 or Patent Literature 4.

With the technology disclosed in Patent Literature 3, the parallax between a left-view video image and a right-view video image constituting a stereoscopic video image is calculated and then modified according to the size of the display showing the stereoscopic video images. The stereoscopic video image is then corrected based on the modified parallax, thereby adjusting the stereoscopic intensity of the stereoscopic video image.

With the technology disclosed in Patent Literature 4, the parallax between a left-view video image and a right-view video image constituting a stereoscopic video image is calculated, and the parallax is then modified so that the amount by which the stereoscopic video image projects or recedes is within a permissible range for the viewer. The stereoscopic video image is then corrected based on the modified parallax, thereby adjusting the stereoscopic intensity of the stereoscopic video image.

### CITATION LIST

### Patent Literature

Patent Literature 1: WO 2005/119675
Patent Literature 2: US Patent Application Publication No. 2008/0036854
Patent Literature 3: Japanese Patent Application Publication No. 2010-45584
Patent Literature 4: Japanese Patent Application Publication No. 2003-284093

### Non-Patent Literature

Non-Patent Literature 1: Lenny Lipton, “Foundations of the Stereoscopic Cinema, A Study in Depth”, Van Nostrand Reinhold, 1982

### SUMMARY OF INVENTION

### Technical Problem

With the above conventional technology, however, the stereoscopic video image after adjustment of the stereoscopic intensity may appear unnatural.

The present invention has been conceived in light of the above problem, and it is an object thereof to provide a stereoscopic intensity adjustment device that allows for adjustment of stereoscopic intensity that yields a highly natural appearance.

### Solution to Problem

In order to fulfill the above objective, a stereoscopic intensity adjustment device according to an aspect of the present invention is a stereoscopic intensity adjustment device for adjusting stereoscopic intensity of stereoscopic video images, comprising: a parallax map acquisition unit configured to acquire a parallax map indicating a parallax value for each pixel in a set of main-view data and sub-view data constituting the stereoscopic video images; an accuracy determination unit configured to determine accuracy of the parallax map; and a stereoscopic intensity adjustment unit configured to adjust the stereoscopic intensity of the stereoscopic video images, wherein in accordance with the accuracy of the parallax map, the stereoscopic intensity adjustment unit selectively performs one of pixel shifting and plane shifting, the pixel shifting referencing the parallax map.

### Advantageous Effects of Invention

The stereoscopic intensity adjustment device according to an aspect of the present invention determines the accuracy of the parallax map that indicates the parallax of the stereoscopic video images, and in accordance with the determined accuracy, selects either a stereoscopic intensity adjustment unit that performs a pixel shift with reference to the parallax map or a stereoscopic intensity adjustment unit that performs a plane shift without reference to the parallax map is selected. The stereoscopic intensity adjustment unit thus reduces deformation of the stereoscopic video images due to adjustment of stereoscopic intensity. The resulting adjustment of stereoscopic intensity thus appears highly natural to viewers.

### BRIEF DESCRIPTION OF DRAWINGS

FIG. 1 illustrates a stereoscopic video viewing system that adopts the stereoscopic adjustment device according to the present embodiment.

FIG. 2 illustrates an example of a left-view image and a right-view image that are output during playback of stereoscopic video images.

FIG. 3 is a diagram illustrating the relationship between the shift amount (amount of parallax) between a left-view image and a right-view image and the amount by which a stereoscopic video image projects or recedes in the case of receding stereoscopy.

FIG. 4 is a diagram illustrating the relationship between the shift amount (amount of parallax) between a left-view image and a right-view image and the amount by which a stereoscopic video image projects or recedes in the case of projecting stereoscopy.

FIG. 5 is a diagram illustrating the relationship between display size and the shift amount of an image on the display.

FIG. 6 is a diagram illustrating an example of the parallax angle for the position to which an object being viewed projects or recedes.

FIG. 7 is a diagram outlining DIBR.

FIG. 8 is a block diagram illustrating an example of the structure of a stereoscopic intensity adjustment device 10.

FIGS. 9A and 9B are diagrams illustrating parallax map generation.

FIG. 10 is a diagram illustrating the assessment of accuracy of a parallax map.

FIG. 11 is a diagram illustrating occlusions that occur during DIBR based on a parallax map.

FIG. 12 is a diagram showing an example of occlusions.

FIG. 13 is a diagram illustrating the relationship between the pixel values in a parallax map and shift amounts.

FIG. 14 is a flowchart illustrating the flow of stereoscopic intensity adjustment by the stereoscopic intensity adjustment device 10.

FIG. 15 is a flowchart illustrating the flow of assessment of accuracy of the parallax map.

FIG. 16 is a block diagram illustrating an example of the structure of a stereoscopic intensity adjustment device 20.

FIG. 17 is a diagram outlining plane shifting.

FIG. 18 is a flowchart illustrating the flow of stereoscopic intensity adjustment by the stereoscopic intensity adjustment device 20.

FIG. 19 is a flowchart showing the flow of plane shifting.

FIG. 20 is a flowchart illustrating the flow of stereoscopic intensity adjustment that includes confirmation of whether the adjustment of stereoscopic intensity is appropriate.

FIG. 21 is a block diagram illustrating an example of the structure of a stereoscopic intensity adjustment device 30.

FIG. 22 is a flowchart illustrating the flow of stereoscopic intensity adjustment by the stereoscopic intensity adjustment device 30.

FIG. 23 is a block diagram illustrating an example of the structure of a stereoscopic intensity adjustment device 40.

### DESCRIPTION OF EMBODIMENTS

### Discovery Serving as a Basis for an Aspect of the Present Invention

First, the discovery serving as a basis for an aspect of the present invention is described.

Viewers often have different preferences as to the amount by which stereoscopic video images project or recede. The amount by which stereoscopic video images project or recede also depends on the size of the display showing the stereoscopic video images.

Conventionally, the stereoscopic intensity of stereoscopic video images is therefore adjusted using the technology disclosed in Patent Literature 3 or Patent Literature 4.

Through intense study, the inventors discovered that adjusting the stereoscopic intensity of stereoscopic video images with the above technology may cause the stereoscopic video images to deform. Such deformed stereoscopic video images appear awkward to viewers.

The inventors examined the reasons why adjusting the stereoscopic intensity causes the stereoscopic video images to deform. Through their investigation, the inventors discovered that the stereoscopic video images deform due to the stereoscopic intensity being adjusted based on a miscalculated parallax value. The inventors also discovered that performing DIBR based on a parallax map with an excessively large amount of parallax causes a large occlusion to occur in the stereoscopic video images after DIBR, thereby causing the stereoscopic video images to be deformed after adjustment of the stereoscopic intensity.

The amount of parallax in a stereoscopic video image is calculated by first searching for corresponding points between the left-view image and the right-view image constituting the stereoscopic video image and then calculating the shift amount in the horizontal direction between the corresponding points. When searching for corresponding points, uniform image regions contain many candidates for corresponding points, making searching more difficult than in image regions with complex patterns. Errors easily occur when attempting to select the correct corresponding point from among the candidates. If an erroneous corresponding point is selected, the stereoscopic intensity ends up being adjusted based on a different amount of parallax than the actual amount of parallax. This results in deformation of the stereoscopic video image.

Furthermore, during DIBR, the coordinates of each pixel are shifted by a different number of pixels. As a result, an occlusion occurs in regions where the values of adjacent pixels in the parallax map suddenly change, i.e. near boundaries of objects included in the image. Typically, occlusions are interpolated using surrounding pixels, but when the occlusion amount becomes excessively large, the resulting image may appear awkward to the user.

### Outline of an Aspect of the Present Invention

Based on the above discovery, the inventors arrived at the following aspects of the present invention.

A stereoscopic intensity adjustment device according to an aspect of the present invention is a stereoscopic intensity adjustment device for adjusting stereoscopic intensity of stereoscopic video images, comprising: a parallax map acquisition unit configured to acquire a parallax map indicating a parallax value for each pixel in a set of main-view data and sub-view data constituting the stereoscopic video images; an accuracy determination unit configured to determine accuracy of the parallax map; and a stereoscopic intensity adjustment unit configured to adjust the stereoscopic intensity of the stereoscopic video images, wherein in accordance with the accuracy of the parallax map, the stereoscopic intensity adjustment unit selectively performs one of pixel shifting and plane shifting, the pixel shifting referencing the parallax map.

In the above aspect, the accuracy of the parallax map that indicates the parallax of the stereoscopic video images is determined, and in accordance with the determined accuracy, either a stereoscopic intensity adjustment unit that performs a pixel shift with reference to the parallax map or a stereoscopic intensity adjustment unit that performs a plane shift without reference to the parallax map is selected. The above aspect thus reduces deformation of the stereoscopic video images due to adjustment of stereoscopic intensity. The resulting adjustment of stereoscopic intensity thus appears highly natural to viewers.

In the stereoscopic intensity adjustment device according to the above aspect of the present invention, the accuracy determination unit may determine the accuracy of the parallax map with reference to the stereoscopic intensity of the stereoscopic video images, the stereoscopic intensity being yielded by the parallax values indicated in the parallax map, and the stereoscopic intensity adjustment unit may select pixel shifting with reference to the parallax map when the stereoscopic intensity of the stereoscopic video images is at least a first predetermined intensity and select plane shifting when the stereoscopic intensity of the stereoscopic video images is at most a second predetermined intensity.

In the above aspect, the stereoscopic intensity of the stereoscopic video images is adjusted by plane shifting when the stereoscopic intensity is within an appropriate value. When the stereoscopic intensity of the stereoscopic video images is greater than an appropriate intensity, the stereoscopic intensity is adjusted by DIBR.

When the stereoscopic intensity of the stereoscopic video images is within an appropriate range, major adjustment of the stereoscopic intensity is unnecessary. Therefore, adjusting the stereoscopic intensity with plane shifting is possible without causing the quality of the stereoscopic images to degrade. On the other hand, when the stereoscopic intensity of the stereoscopic video images exceeds an appropriate intensity, it becomes necessary to change the stereoscopic intensity to be within an appropriate level. Therefore, adjusting the stereoscopic intensity with DIBR allows for adjustment of the sense of depth whereby the stereoscopic video images appear to project or recede.

In the stereoscopic intensity adjustment device according to the above aspect of the present invention, the stereoscopic intensity of the stereoscopic video images may be based on parallax angle, and the accuracy determination unit may determine the accuracy of the parallax map by calculating the parallax angle with reference to the parallax values indicated in the parallax map and comparing the calculated parallax angle with a predetermined threshold.

The above aspect allows for adjustment of stereoscopic intensity of stereoscopic video images by selecting either plane shifting or DIBR based on the stereoscopic intensity as determined by the parallax angle.

In the stereoscopic intensity adjustment device according to the above aspect of the present invention, the parallax map acquisition unit may acquire the parallax map by searching for corresponding points between the main-view data and the sub-view data, the accuracy determination unit may determine the accuracy of the parallax map with reference to an amount of error occurring when the parallax map acquisition unit searches for the corresponding points, and the stereoscopic intensity adjustment unit may select pixel shifting with reference to the parallax map when the accuracy throughout the parallax map is at least a first predetermined accuracy and select plane shifting when the accuracy throughout the parallax map is at most a second predetermined accuracy.

The above aspect prevents a degradation in quality of the stereoscopic video images after adjustment of the stereoscopic intensity due to adjustment of stereoscopic intensity based on erroneous detection when searching for corresponding points.

In the stereoscopic intensity adjustment device according to the above aspect of the present invention, the amount of error may be the number of pixels for which no corresponding point is detected and of pixels for which a plurality of candidate corresponding points are detected during the search for corresponding points, and the accuracy determination unit may determine the accuracy of the parallax map by comparing the number of pixels for which no corresponding point is detected and of pixels for which a plurality of candidate corresponding points are detected during the search for corresponding points with a predetermined threshold.

In the above aspect, the amount of error is calculated as the pixels for which no corresponding point is detected and the pixels for which a plurality of candidate corresponding points are detected, and the accuracy of the parallax map is determined based on the number of pixels.

The stereoscopic intensity adjustment device according to the above aspect of the present invention may further comprise a screen size acquisition unit configured to acquire a size of a screen on which the stereoscopic video images are displayed, wherein during the pixel shifting, the stereoscopic intensity adjustment unit changes an amount of parallax indicated by the parallax map with reference to the size of the screen and the accuracy of the parallax map, and regenerates the sub-view data by shifting coordinates of each pixel in the main-view data by a number of pixels corresponding to the changed amount of parallax.

The above aspect allows for improvement of the accuracy of the parallax map by changing the parallax map based on the size of the display and the accuracy of the parallax map. This allows for stereoscopic adjustment that yields an even more natural appearance, thus alleviating eyestrain and offering viewers a more realistic experience.

In the stereoscopic intensity adjustment device according to the above aspect of the present invention, the accuracy determination unit may determine the accuracy of a foreground region and of a background region in the parallax map, and during the pixel shifting, the stereoscopic intensity adjustment unit may invalidate the amount of parallax in the background region of the parallax map when the accuracy of the background region of the parallax map is less than a predetermined accuracy.

The above aspect invalidates the amount of parallax in a background region in which a large number of errors have occurred in the search for corresponding points, thereby improving the accuracy of the parallax map.

In the stereoscopic intensity adjustment device according to the above aspect of the present invention, the accuracy determination unit may determine the accuracy of a foreground region and a background region in the parallax map, and during the pixel shifting, the stereoscopic intensity adjustment unit may average the amount of parallax in the foreground region of the parallax map when the accuracy of the foreground region of the parallax map is less than a predetermined accuracy.

The above aspect averages the amount of parallax in a foreground region where a large number of errors have occurred in the search for corresponding points, thereby improving the accuracy of the parallax map.

In the stereoscopic intensity adjustment device according to the above aspect of the present invention, during the pixel shifting, the stereoscopic intensity adjustment unit may extract an outline of an object included in the foreground region of the parallax map and average the amount of parallax in the foreground region of the parallax map when accuracy of extraction of the outline is at least a predetermined accuracy.

The above aspect avoids a decrease in the accuracy of the parallax map due to averaging of the amount of parallax in the foreground region of the parallax map, since the amount of parallax in the foreground region of the parallax map is averaged under the condition that the accuracy of the outline extracted for the object in the foreground region be at least a predetermined accuracy.

In the stereoscopic intensity adjustment device according to the above aspect of the present invention, the accuracy determination unit may determine the accuracy of the parallax map with reference to the stereoscopic intensity of the stereoscopic video images, the stereoscopic intensity being yielded by the parallax values indicated in the parallax map, and during the pixel shifting, the stereoscopic intensity adjustment unit may reduce the amount of parallax indicated by the parallax map when the stereoscopic intensity of the stereoscopic video images is at least a predetermined intensity.

When the stereoscopic intensity of the stereoscopic video images is at least a predetermined threshold, the above aspect reduces the amount of parallax indicated by the parallax map, thereby reducing the occlusion amount occurring due to adjustment of the stereoscopic intensity.

In the stereoscopic intensity adjustment device according to the above aspect of the present invention, during the pixel shifting, the stereoscopic intensity adjustment unit may change the amount of parallax indicated by the parallax map so that an amount by which the stereoscopic video images project or recede with respect to the size of the screen is based on a predetermined parallax angle.

The above aspect adjusts the stereoscopic intensity to be based on a predetermined parallax angle, thereby providing stereoscopic video images that cause little visual fatigue or sense of awkwardness for the user.

In the stereoscopic intensity adjustment device according to the above aspect of the present invention, during the pixel shifting, the stereoscopic intensity adjustment unit may change the amount of parallax indicated by the parallax map so that a ratio between a viewing distance and an amount by which the stereoscopic video images project or recede becomes a predetermined fixed value.

The above aspect allows for provision of stereoscopic video images with a stereoscopic intensity appropriate for the size of the screen on which the stereoscopic video images are shown.

In the stereoscopic intensity adjustment device according to the above aspect of the present invention, during the pixel shifting, when the size of the screen is at least a first predetermined size, the stereoscopic intensity adjustment unit may change the amount of parallax indicated by the parallax map so that an amount by which the stereoscopic video images project or recede with respect to the size of the screen is based on a predetermined parallax angle, and when the size of the screen is at most a second predetermined size, the stereoscopic intensity adjustment unit may change the amount of parallax indicated by the parallax map so that an amount by which the stereoscopic video images project or recede with respect to the size of the screen is based on an angle that is at least a predetermined parallax angle and is within a parallax angle indicating a limit for stereoscopic integration.

When the size of the screen on which the stereoscopic video images are shown is large, the above aspect prevents an increase in the amount of parallax from causing the stereoscopic intensity to exceed a predetermined parallax angle, which would lead to visual fatigue or a sense of awkwardness. Furthermore, when the size of the screen displaying the stereoscopic video images is small, this prevents a decrease in the amount of parallax from causing the left-view image in the right-view image to be recognized as separate images, which would make stereoscopic integration difficult.

The stereoscopic intensity adjustment device according to the above aspect of the present invention may further comprise planes including a left-view plane and a right-view plane; and a rendering engine configured to write video data in the planes, wherein when the accuracy throughout the parallax map is at least a first predetermined accuracy, the rendering engine writes main-view data and sub-view data after the adjustment of stereoscopic intensity into the planes, and when the accuracy throughout the parallax map is at most a second predetermined accuracy, the rendering engine writes the main-view data before the adjustment of stereoscopic intensity into both the left-view plane and the right-view plane.

The above aspect allows for 3D display when the accuracy of the parallax map is high and 2D display when the accuracy of the parallax map is poor.

In the stereoscopic intensity adjustment device according to the above aspect of the present invention, the parallax map acquisition unit may reacquire the parallax map when the accuracy of the parallax map is less than a predetermined accuracy.

The above aspect reacquires the parallax map when the accuracy of the parallax map is poor, thereby offering the promise of increased accuracy of the parallax map.

In the stereoscopic intensity adjustment device according to the above aspect of the present invention, the parallax map acquisition unit may reacquire the parallax map using a different method than during a previous acquisition of the parallax map.

The above aspect reacquires the parallax map using a different method than during the previous acquisition of the parallax map, thereby offering the promise of increased accuracy of the parallax map.

A stereoscopic intensity adjustment method according to an aspect of the present invention is a stereoscopic intensity adjustment method for adjusting stereoscopic intensity of stereoscopic video images, comprising the steps of: acquiring a parallax map indicating a parallax value for each pixel in a set of main-view data and sub-view data constituting the stereoscopic video images; determining accuracy of the parallax map; and adjusting the stereoscopic intensity of the stereoscopic video images, wherein during the step of adjusting the stereoscopic intensity, in accordance with the accuracy of the parallax map, one of pixel shifting and plane shifting is selectively performed, the pixel shifting referencing the parallax map.

The above aspect provides a stereoscopic intensity adjustment method that allows for a reduction in deformation of stereoscopic video images due to adjustment of stereoscopic intensity.

A program according to an aspect of the present invention is for causing a computer to perform stereoscopic intensity adjustment to adjust stereoscopic intensity of stereoscopic video images, the program causing the computer to perform the steps of: acquiring a parallax map indicating a parallax value for each pixel in a set of main-view data and sub-view data constituting the stereoscopic video images; determining accuracy of the parallax map; and adjusting the stereoscopic intensity of the stereoscopic video images, wherein during the step of adjusting the stereoscopic intensity, in accordance with the accuracy of the parallax map, one of pixel shifting and plane shifting is selectively performed, the pixel shifting referencing the parallax map.

The above aspect provides a program that allows for a reduction in deformation of stereoscopic video images due to adjustment of stereoscopic intensity.

An integrated circuit according to an aspect of the present invention is an integrated circuit for stereoscopic intensity adjustment to adjust stereoscopic intensity of stereoscopic video images, comprising: a parallax map acquisition unit configured to acquire a parallax map indicating a parallax value for each pixel in a set of main-view data and sub-view data constituting the stereoscopic video images; an accuracy determination unit configured to determine accuracy of the parallax map; and a stereoscopic intensity adjustment unit configured to adjust the stereoscopic intensity of the stereoscopic video images, wherein in accordance with the accuracy of the parallax map, the stereoscopic intensity adjustment unit selectively performs one of pixel shifting and plane shifting, the pixel shifting referencing the parallax map.

The above aspect provides an integrated circuit that allows for a reduction in deformation of stereoscopic video images due to adjustment of stereoscopic intensity.

A recording medium according to an aspect of the present invention has recorded thereon a program for causing a computer to perform stereoscopic intensity adjustment to adjust stereoscopic intensity of stereoscopic video images, the program causing the computer to perform the steps of: acquiring a parallax map indicating a parallax value for each pixel in a set of main-view data and sub-view data constituting the stereoscopic video images; determining accuracy of the parallax map; and adjusting the stereoscopic intensity of the stereoscopic video images, wherein during the step of adjusting the stereoscopic intensity, in accordance with the accuracy of the parallax map, one of pixel shifting and plane shifting is selectively performed, the pixel shifting referencing the parallax map.

The above aspect provides a recording medium that allows for a reduction in deformation of stereoscopic video images due to adjustment of stereoscopic intensity.

### Embodiment 1

The following describes embodiments of the present invention with reference to the drawings.

### Form of Use of Stereoscopic Intensity Adjustment Device

First, a form of use of the stereoscopic intensity adjustment device according to the present embodiment is described.

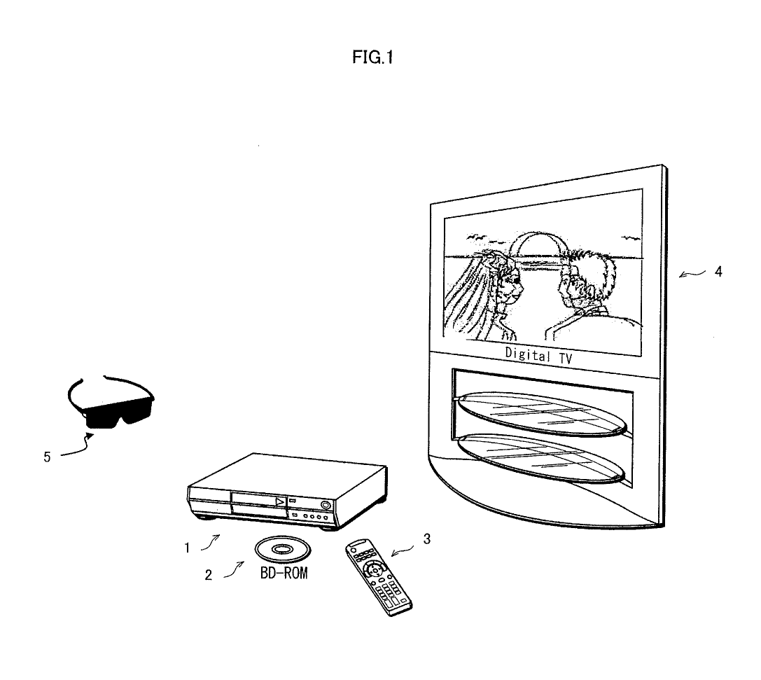

FIG. 1 illustrates a stereoscopic video viewing system that adopts the stereoscopic adjustment device according to the present embodiment. This system includes, for example, a playback device 1, a recording medium 2, an operating device 3, a display device 4, and 3D glasses 5. The stereoscopic adjustment device of the present embodiment is mounted on the playback device 1 or the display device 4 and adjusts the stereoscopic intensity of stereoscopic video images that are played back and displayed.

The playback device 1 is a BD player, a DVD player, or other such player that reads and plays back stereoscopic video images from the recording medium 2. The playback device 1 is connected to the display device 4 by an HDMI (High-Definition Multimedia Interface) cable or the like and transmits the stereoscopic video images that have been read to the display device 4.

The recording medium 2 is an optical disc, such as a BD-ROM (Blu-ray Disc Read Only Memory) or a DVD-ROM (Digital Versatile Disk Read Only Memory), or a semiconductor memory card such as an SD card (Secure Digital memory card) or the like. The recording medium 2 provides the above home theater system with a movie, for example.

The operating device 3 is a device such as a remote control that receives operations from the user directed towards a hierarchical Graphical User Interface (GUI) displayed on the display device 4. In order to receive the user operations, the operating device 3 is provided with keys such as the following: a menu key that calls a menu, arrow keys for switching the focus between GUI components of the menu, an enter key for selecting one of the GUI components of the menu, a return key to return to a higher level of hierarchical menu, and number keys.

The display device 4 shows, on a display, the stereoscopic video images played back by the playback device 1. The display device 4 also receives a transport stream of a digital broadcast via an antenna and shows, on the display, stereoscopic video images obtained from the received transport stream. Additionally, the display device 4 acquires a video stream over an IP network and shows, on the display, stereoscopic video images obtained from the acquired video stream. The display device 4 provides the user with an interactive operating environment by showing menus or the like on the display.

The 3D glasses 5 are worn by the viewer while viewing stereoscopic video images. The 3D glasses 5 allow for stereoscopic viewing in conjunction with other devices, such as the playback device 1 that plays back stereoscopic video images and the display device 4 that controls the display of the images.

This concludes the description of a form of use of the stereoscopic intensity adjustment device according to the present embodiment. Next, the principle behind stereoscopic viewing is described.

### Principle Behind Stereoscopic Viewing

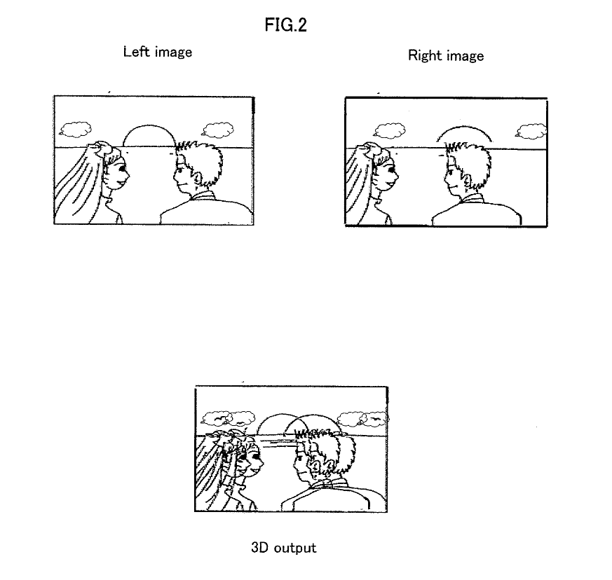

FIG. 2 illustrates an example of a left-view image and a right-view image that are output during playback of stereoscopic video images.

As illustrated in FIG. 2, during playback of stereoscopic video images, the display device 4 displays video images with the parallax therebetween (left-view images and right-view images).

Consider the relationship between objects included in the left-view image and objects included in the right-view image. With respect to objects included in the left-view image that appear towards the front of the image (for example, the man and woman), the corresponding objects included in the right-view image are positioned further to the left. On the other hand, objects appearing towards the back of the image (for example, the sun and the clouds) are positioned further to the right than the corresponding objects included in the right-view image.

Since human perception of three dimensions is based on differences between images entering the left and the right eye, displaying such a left-view image and right-view image with a parallax therebetween and providing the images independently to the left and right eye of the viewer causes the viewer to perceive depth.

The left-view image and right-view image are independently provided to the left and right eye of the viewer by having the 3D glasses switch between transmitting and blocking light, or by obstructing parallax through the use of a parallax barrier, a lenticular lens, or the like.

This concludes the description of the principle behind stereoscopic viewing. Next, the relationship between the size of the display and the stereoscopic video content is described.

### Relationship Between Size of Display and Stereoscopic Video Content

The amount by which stereoscopic video images project or recede depends on the size of the display showing the stereoscopic video images. Therefore, a content author assumes a certain display size for the content and creates the content so that the stereoscopic video images project or recede by an optimal amount when the content is viewed on a display with the assumed size.

For example, in the case of a movie, content is created assuming that the display size corresponds to a theater screen or a household television set with a large screen. On the other hand, for stereoscopic video images that are filmed with a household 3D digital camera or the like, content is created assuming that images are to be viewed on a display with a relatively small screen, such as a photo frame or a finder.

When viewing stereoscopic video images on a large-screen display, the shift between the left-view image and the right-view image on the display is larger than when viewing on a small-screen display. As a result, content created for a large screen has a smaller amount of parallax than content created for a small screen. When viewing content created for a large screen on a small-screen display, viewers therefore do not perceive a sufficient stereoscopic effect.

On the other hand, when viewing stereoscopic video images on a small-screen display, the shift between the left-view image and the right-view image on the display is smaller than when viewing on a large-screen display. As a result, content created for a small screen has a larger amount of parallax than content created for a large screen. When viewing content created for a small screen on a large-screen display, viewers therefore may perceive a stereoscopic effect that is too intense. Stereoscopic video images with a stereoscopic effect that is too intense appear awkward to the viewer.

Due to personal differences in the perception of stereoscopic video images, viewers also have different preferences regarding the amount by which images project or recede. Some viewers enjoy being greatly surprised by stereoscopic images. On the other hand, since images that project by a large amount may excessively surprise or frighten viewers, some viewers prefer images that do not project by a great amount.

The stereoscopic intensity adjustment device according to an aspect of the present invention resolves this problem by adjusting the stereoscopic intensity of stereoscopic video images in accordance with display size and with user preference for stereoscopic intensity.

This concludes the description of the relationship between the size of the display and the stereoscopic video content. Next, the relationship between the shift amount (amount of parallax) between a left-view image and a right-view image and the amount by which a stereoscopic video image projects or recedes is described.

Relationship Between Shift Amount and the Amount by which an Image Projects or Recedes

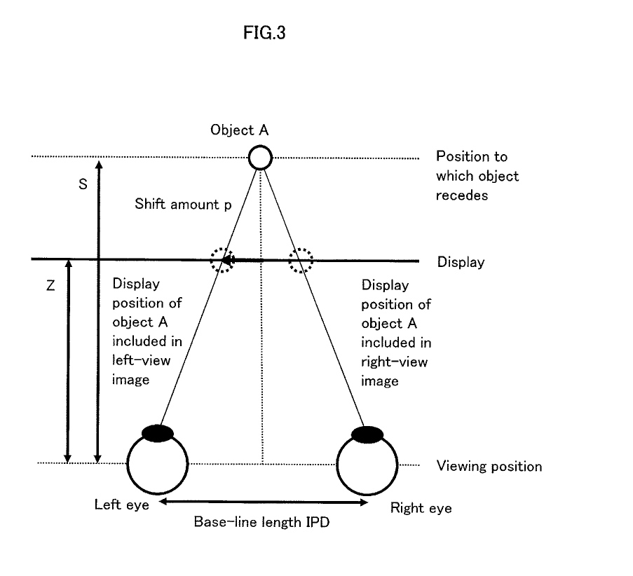

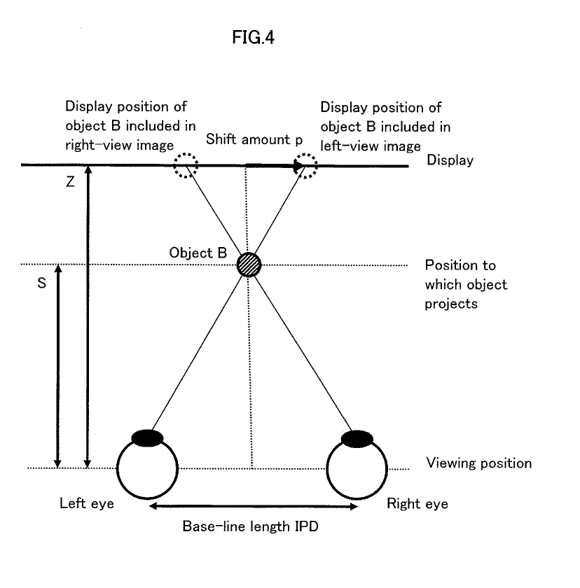

FIGS. 3 and 4 are diagrams illustrating the relationship between the shift amount (amount of parallax) between a left-view image and a right-view image and the amount by which a stereoscopic video image projects or recedes.

In these figures, the solid line connecting the left pupil with the display position of an object A included in the left-view image is the line of sight of the left eye. Similarly, the solid line connecting the right pupil with the display position of an object A included in the right-view image is the line of sight of the right eye. The viewer perceives the object A as being located at the intersection of the lines of sight of the left eye and the right eye (the formed image point).

Stereoscopic effects include an effect to cause an object to project (projecting stereoscopy) and an effect causing an object to recede (receding stereoscopy). First, the relationship with the shift amount in the case of receding stereoscopy is described with reference to FIG. 3.

In FIG. 3, p indicates the shift amount (amount of parallax) in the left-view image and the right-view image, Z indicates the distance from the viewing position to the display, S indicates the distance from the viewing position to the formed image, and IPD indicates the base-line length (interpupillary distance).

As shown in FIG. 3, the relationship in Equation 1 below holds between the distance S from the viewing position to the formed image, the distance Z from the viewing position to the display, the shift amount p between the left-view image and the right-view image, and the base-line length IPD based on the triangular scaling relationship between a triangle with vertices at the left pupil, the right pupil, and the formed image point and a triangle with vertices at the display position of the object A included in the left-view image, the display position of the object A included in the right-view image, and the formed image point.

S−Z:S=p:IPD/2 Equation 1

Based on the relationship in Equation 1, the shift amount p between the left-view image and the right-view image is expressed as in Equation 2 below.

p=IPD/2×(1−Z/S) Equation 2

FIG. 4 is a diagram illustrating the relationship between the shift amount (amount of parallax) between a left-view image and a right-view image and the amount by which a stereoscopic video image projects in the case of projecting stereoscopy. As is the case with receding stereoscopy, the relationships in Equations 1 and 2 above also hold, as shown in FIG. 4, between the distance S from the viewing position to the formed image, the distance Z from the viewing position to the display, the shift amount p between the left-view image and the right-view image, and the base-line length IPD based on the triangular scaling relationship between a triangle with vertices at the left pupil, the right pupil, and the formed image point and a triangle with vertices at the display position of the object A included in the left-view image, the display position of the object A included in the right-view image, and the formed image point.

In Equations 1 and 2 above, the shift amount p is calculated with reference to the position at which the object A is projected on the display. Therefore, the shift amount with reference to the position of object A included in the left-view image is twice the value of p in Equations 1 and 2.

This concludes the description of the relationship between the shift amount (amount of parallax) between a left-view image and a right-view image and the amount by which a stereoscopic video image projects or recedes. Next, the relationship between display size and the shift amount of an image on the display is described.

### Relationship Between Display Size and Shift Amount of Image on Display

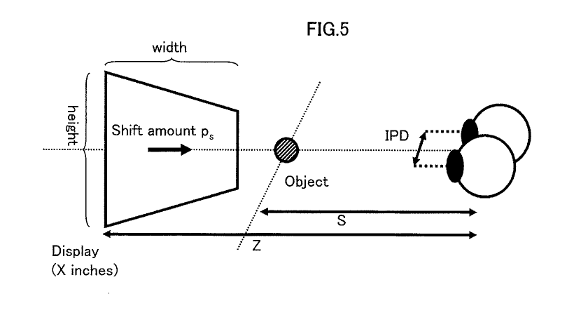

FIG. 5 is a diagram illustrating the relationship between display size and the shift amount of an image on the display.

In FIG. 5, X is the size of a display having a certain width and height. Z indicates the distance from the viewing position to the display. S indicates the distance from the viewing position to the formed image. IPD indicates the base-line length (interpupillary distance), and pₛ indicates the shift amount (as a number of pixels) of an image on the display.

In FIG. 5, the screen size X of the display is defined in terms of the width and height of the display in Equation 3 below.

X²=width²+height² Equation 3

The aspect ratio m:n of the display is defined in terms of the width and height of the display in Equation 4 below.

width:height=m:n Equation 4

Based on Equations 3 and 4 above, the width of the display is given by

Equation 5 below.

$$width = X \sqrt{\frac{{m}^{2}}{{m}^{2} + {n}^{2}}} \qquad Equation 5$$

Letting the number of pixels in the horizontal direction of the display be w_pix, the horizontal length of one pixel is given by the width of the display divided by the number of pixels w_pix in the horizontal direction of the display. Letting the number of pixels in the vertical direction of the display be h_pix, the vertical length of one pixel is given by the height of the display divided by the number of pixels h_pix in the vertical direction of the display.

Accordingly, based on Equations 2 and 5 above, the shift amount (as a number of pixels) of an image on the display is given by Equation 6 below.

$$\begin{matrix}Ps = \frac{IPD}{2} \times ( Z / S - 1 ) \times \frac{w\_pix}{width} \\ = \frac{IPD}{2} \times ( Z / S - 1 ) \times \frac{w\_pix}{X} \sqrt{\frac{{m}^{2} + {n}^{2}}{{m}^{2}}}\end{matrix} \qquad Equation 6$$

The value of pₛ is the shift amount (as a number of pixels) with reference to the position at which an object is projected on the display. Therefore, when generating the right-view image by shifting pixels in the left-view image, it is necessary to shift by double the number of pixels indicated by pₛ.

As indicated by Equation 6, assuming that the aspect ratio of the display is the same and that the number of pixels in the images shown on the display is the same, then even if the value of p indicated by Equation 2 is the same, it is clear that the value of pₛ that is calculated will differ if the size of the display differs.

Accordingly, in order for stereoscopic video images to project or recede by the same amount on a display with a different size, it is necessary to increase the shift amount pₛ of the image on the display as the size of the display decreases.

This is because if the value of pₛ for a large display A is used without modification as the value of pₛ for a display B that is smaller than the display A, the amount by which video images project or recede in the small display B will be less than in the display A.

Since the typical interpupillary distance for an adult male is approximately 6.5 cm, the base-line length IPD is taken to be 6.5 cm. Taking a Full Hi-Vision display as an example, the aspect ratio m:n is 16:9, and the horizontal number of pixels in the display w_pix is 1920. Substituting these values into Equation 6, the shift amount pₛ of an image on the display is as follows.

pₛ=(2818.68/X)×(Z/S−1)

If an object is caused to project from the display by 10% of the distance from the viewing position to the display, then S=0.9Z. Accordingly, the shift amount pₛ of an image on the display is as follows.

pₛ=313.19/X

Since one inch is 2.54 cm, the shift amount for an image on a 50-inch display, for example, would be six pixels. On the other hand, the shift amount for an image on a 5-inch display, for example, would be 63 pixels.

In order for stereoscopic video images to project or recede by the same amount, it thus becomes necessary to change the shift amount of the image in accordance with the display size.

This concludes the description of the relationship between display size and the shift amount of an image on the display. Next, the relationship between parallax angle and the amount by which stereoscopic video images project or recede is described.

Relationship Between Parallax Angle and Amount by which Images Project or Recede

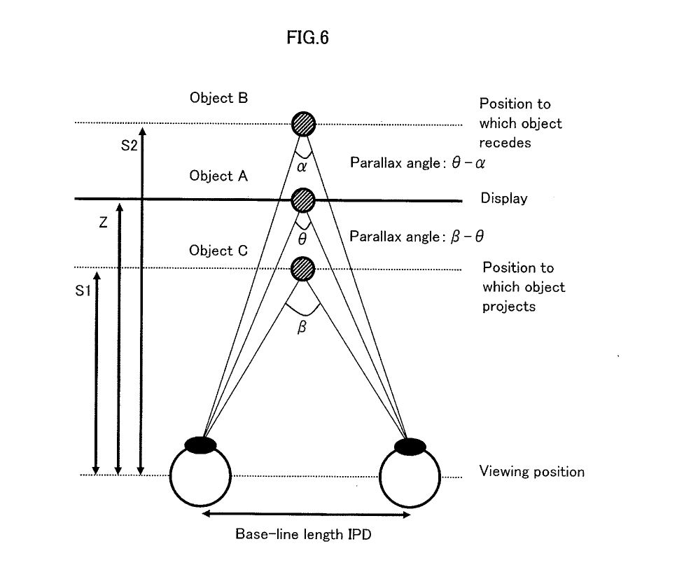

FIG. 6 is a diagram illustrating an example of the parallax angle for the position to which an object being viewed projects or recedes.

In FIG. 6, α is the angle (angle of convergence) formed between the line of sight for the left eye and the line of sight for the right eye when viewing, from the viewing position, an object B that has receded. On the other hand, β is the angle (angle of convergence) formed between the line of sight for the left eye and the line of sight for the right eye when viewing, from the viewing position, an object C that has projected forward. Finally, θ is the angle (angle of convergence) formed between the line of sight for the left eye and the line of sight for the right eye when viewing, from the viewing position, an object at the display position A.

In this context, the parallax angle is defined by the difference between the angle of convergence when viewing a point on the display and the angle of convergence when viewing a stereoscopic object determined by binocular parallax. Accordingly, in the example in FIG. 6, the parallax angle when viewing object B which has receded is θ−α. The parallax angle when viewing object C, which has projected forward, is β−θ.

One known standard for viewing stereoscopic video images comfortably, without visual fatigue or a sense of awkwardness, is for the parallax angle to be within a predetermined angle. For example, the 3D Consortium recommends that for comfortable viewing of stereoscopic video images, the parallax angle should be 1 degree or less. If the parallax angle is 2 degrees or greater, the left-view image and the right-view image are perceived as different images, making stereoscopic integration difficult.

For example, if the amount by which images project or recede on a 50-inch display is restricted to be based on a parallax angle of 1 degree or less, images can project by up to 33% of the distance from the viewing position to the display, and images can recede by up to 101% of the distance from the viewing position to the display. By contrast, if the amount by which images project or recede on a 5-inch display is restricted to be based on a parallax angle of 1 degree or less, images can project by up to 5% of the distance from the viewing position to the display, and images can recede by up to 5% of the distance from the viewing position to the display.

With reference to FIG. 4 and FIG. 6, the base-line length IPD for projecting stereoscopy is expressed as follows in terms of the angle of convergence β.

IPD=2×S₁×tan(β/2)

The value 2p, which is double the shift amount p, is expressed as follows in terms of the angle of convergence β.

2p=2×(Z−S₁)×tan(β/2)

The base-line length IPD in the case of projecting stereoscopy is expressed as follows in terms of the angle of convergence θ.

IPD=2×Z×tan(θ/2)

The value 2p, which is double the shift amount p, is expressed in Equation 7 below in terms of the angles of convergence β and θ.

2p=2×Z×{tan(β/2)−tan(θ/2)} Equation 7

With reference to FIG. 3 and FIG. 6, the base-line length IPD for receding stereoscopy is expressed as follows in terms of the angle of convergence α.

IPD=2×S₂×tan(α/2)

The value 2p, which is double the shift amount p, is expressed as follows in terms of the angle of convergence α.

2p=2×(S₂−Z)×tan(α/2)

The base-line length IPD for receding stereoscopy is expressed as follows in terms of the angle of convergence θ.

IPD=2×Z×tan(θ/2)

The value 2p, which is double the shift amount p, is expressed in Equation 8 below in terms of the angles of convergence α and θ.

2p=2×Z×{tan(θ/2)−tan(α/2)} Equation 8

In Equations 7 and 8 above, the value of the angle of convergence θ on the display is determined by the distance Z from the viewing position to the display and the base-line length (interpupillary distance) IPD. For example, if the distance from the viewing position to the display is 1,200 mm and the base-line length (interpupillary distance) is 65 mm, the angle of convergence θ on the display is 2.86 degrees.

Accordingly, if the upper limit of the parallax angle is provided, the upper limit on the amount of parallax can be calculated using the above Equations 7 and 8. For example, given the conditions that the distance from the viewing position to the display is 1,200 mm and the base-line length (interpupillary distance) is 65 mm, then if the upper limit of the parallax angle is one degree, the angle of convergence β at the point at which images project is 3.86 degrees, and the upper limit on the amount of parallax on the display is 21 mm.

This concludes the description of the relationship between parallax angle and the amount by which stereoscopic video images project or recede. Next, Depth Image Based Rendering (DIBR) is described.

### Depth Image Based Rendering (DIBR)

Depth Image Based Rendering (DIBR), also referred to as pixel shifting, is technology to generate a stereoscopic image composed of images from multiple viewpoints by shifting each pixel in an image horizontally based on a parallax map in order to generate an image from a different viewpoint than the original image.

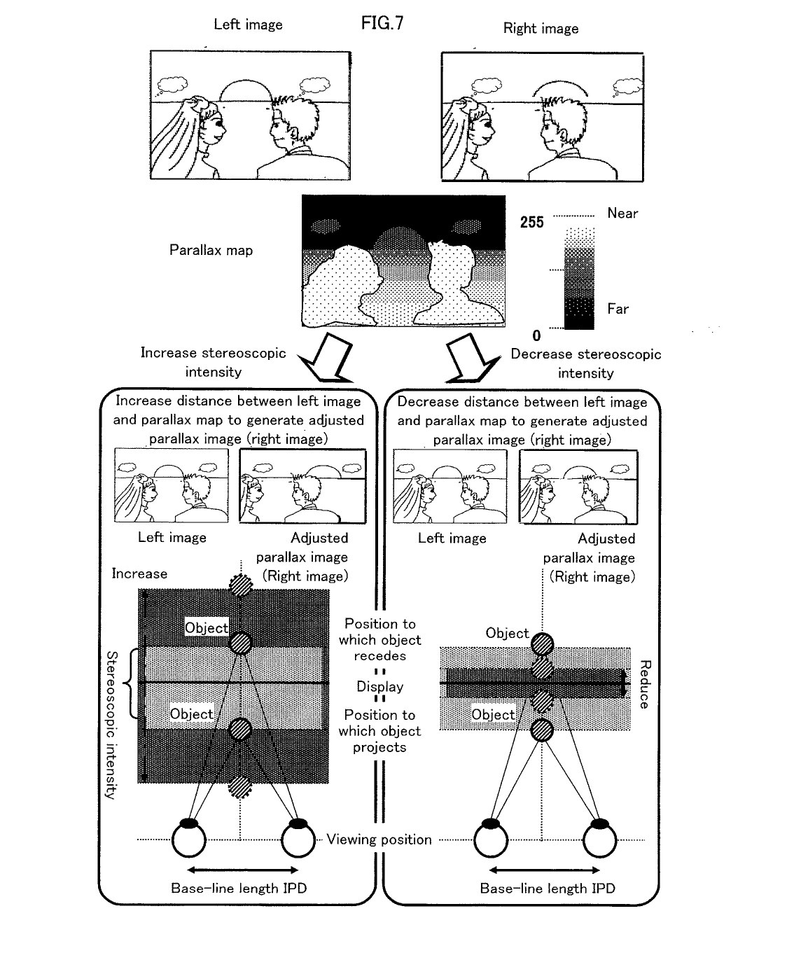

FIG. 7 is a diagram outlining DIBR. As illustrated in FIG. 7, to perform DIBR, a left-view image and a right-view image, as well as a parallax map indicating the parallax between the left-view image and the right-view image, are first acquired.

In the example in FIG. 7, the parallax map (also referred to as a depth map) is an image representing the amount of parallax or the distance in the depth direction as one of 256 levels of brightness. As an image is located further forward, the color becomes whiter, whereas the color becomes blacker as an image is located further back.

The stereoscopic intensity is adjusted during DIBR by first modifying the amount of parallax or distance in the depth direction shown by the parallax map and then shifting each pixel in the left-view image by a number of pixels corresponding to the modified amount of parallax or distance in the depth direction, thereby generating an adjusted parallax image. Outputting this adjusted parallax image as the right-view image allows for adjustment of the stereoscopic intensity of the stereoscopic video image. As shown in FIG. 7, in order to increase the stereoscopic intensity, the adjusted parallax image is generated by increasing the amount of parallax or distance in the depth direction shown by the parallax map. As a result, the position to which an object projects moves even further forward, whereas the position to which an object recedes moves even further back, thereby increasing the stereoscopic intensity of the stereoscopic video image. On the other hand, in order to decrease the stereoscopic intensity, the adjusted parallax image is generated by reducing the amount of parallax or distance in the depth direction shown by the parallax map. As a result, the position to which an object projects moves back, whereas the position to which an object recedes moves forward, thereby decreasing the stereoscopic intensity of the stereoscopic video image.

This concludes the description of Depth Image Based Rendering (DIBR). Next, the structure of the stereoscopic intensity adjustment device is described.

### Structure of Stereoscopic Intensity Adjustment Device According to Embodiment 1

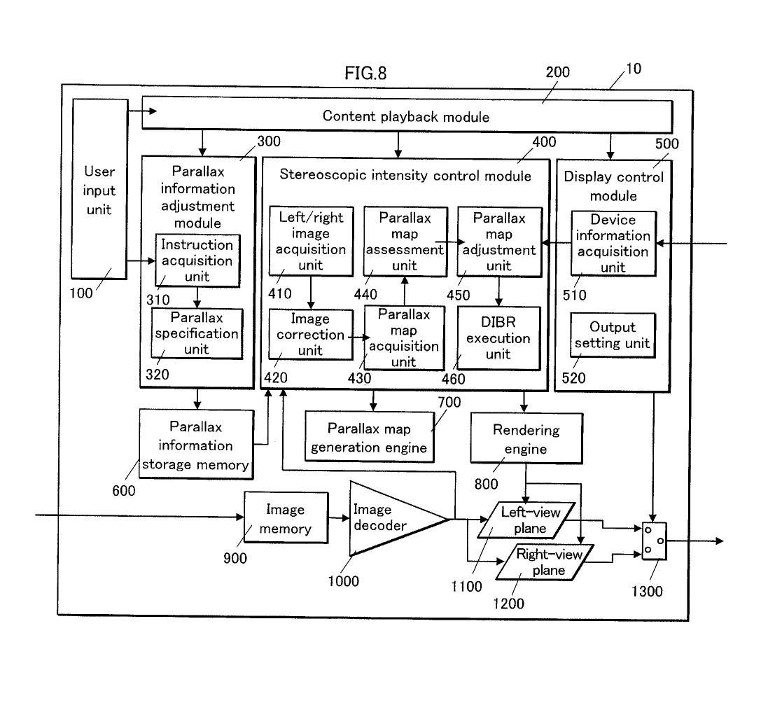

FIG. 8 is a block diagram illustrating an example of the structure of a stereoscopic intensity adjustment device 10. As shown in FIG. 8, the stereoscopic intensity adjustment device 10 includes a user input unit 100, a content playback module 200, a parallax information adjustment module 300, a stereoscopic intensity control module 400, a display control module 500, a parallax information storage memory 600, a parallax map generation engine 700, a rendering engine 800, an image memory 900, an image decoder 1000, a left-view plane 1100, a right-view plane 1200, and an output switch 1300. The parallax information adjustment module 300 includes an instruction acquisition unit 310 and a parallax specification unit 320. The stereoscopic intensity control module 400 includes a left/right image acquisition unit 410, an image correction unit 420, a parallax map acquisition unit 430, a parallax map assessment unit 440, a parallax map adjustment unit 450, and a DIBR execution unit 460. The display control module 500 includes a device information acquisition unit 510 and an output setting unit 520. These structures are described below.

### User Input Unit 100

The user input unit 100 has a function to receive input from the user. Specifically, the user input unit 100 receives input of an instruction to play back stereoscopic video images, an instruction to adjust stereoscopic intensity, a parameter indicating the user's preference for the degree of stereoscopic intensity, and the like. Upon receiving an instruction or parameter, the user input unit 100 transmits the received instruction or parameter to the content playback module 200 or the parallax information adjustment module 300.

### Content Playback Module 200

In accordance with an instruction to play back stereoscopic video images or an instruction to adjust stereoscopic intensity received by the user input unit 100, the content playback module 200 issues an instruction to play back stereoscopic video images or issues an instruction to adjust the stereoscopic intensity of the stereoscopic video images.

### Parallax Information Adjustment Module 300

The parallax information adjustment module 300 includes the instruction acquisition unit 310 and the parallax specification unit 320. The parallax information adjustment module 300 has a function to generate and adjust parallax information indicating the amount of parallax corresponding to the user preferred amount by which an image projects or recedes, in accordance with the parameter indicated by the stereoscopic intensity received from the user input unit 100.

### Instruction Acquisition Unit 310

The instruction acquisition unit 310 has a function to acquire a parameter indicating stereoscopic intensity from the user input unit 100. The parameter indicating stereoscopic intensity may, for example, be an upper limit on the parallax angle. The parameter may also indicate a degree of stereoscopic intensity, such as “strong”, “medium”, or “weak”. Alternatively, the parameter may indicate the maximum amount by which an image projects or recedes as a proportion of the distance from the viewing position to the display. A parallax angle indicating the limit for stereoscopic integration is another alternative for the parameter.

### Parallax Specification Unit 320, Parallax Information Storage Memory 600

The parallax specification unit 320 has a function to change the parameter, acquired by the instruction acquisition unit 310, that indicates stereoscopic intensity into an upper limit on the amount of parallax.

If the parameter indicating stereoscopic intensity is an upper limit on the parallax angle, the upper limit on the parallax of stereoscopic video images is determined from the upper limit on the parallax angle. Specifically, the parallax of stereoscopic video images is determined from the upper limit on the parallax angle based on Equations 7 and 8 above.

If the parameter indicating stereoscopic intensity indicates the maximum amount by which an image projects or recedes as a proportion of the distance to the display size, the upper limit on the parallax of stereoscopic video images is determined from the parameter indicating stereoscopic intensity, based on Equation 6 above.

The upper limit on the parallax of stereoscopic video images may also be determined based on Equation 6 above so that the maximum amount by which an image projects or recedes as a proportion of the display size becomes a predetermined fixed value.

If the parameter indicating stereoscopic intensity is a parallax angle indicating the limit for stereoscopic integration, the upper limit on the parallax of stereoscopic video images may be determined by restricting the parallax angle to be within the parallax angle indicating the limit for stereoscopic integration.

The parallax information storage memory B600 has a function to store the upper limit on the parallax, generated by the parallax specification unit 320, as parallax information.

### Stereoscopic Intensity Control Module 400

The stereoscopic intensity control module 400 includes the left/right image acquisition unit 410, the image correction unit 420, the parallax map acquisition unit 430, the parallax map assessment unit 440, the parallax map adjustment unit 450, and the DIBR execution unit 460. The stereoscopic intensity control module 400 has a function to acquire stereoscopic video images and adjust the stereoscopic intensity of the acquired stereoscopic video images.

### Left/Right Image Acquisition Unit 410

The left/right image acquisition unit 410 has a function to acquire, from among images stored in the image memory 900, the left-view image and the right-view image indicated by the content playback module 200.

### Image Correction Unit 420

In order to facilitate generation of the parallax map, the image correction unit 420 has a function to correct the left-view image and the right-view image acquired by the left/right image acquisition unit 410. Specifically, the image correction unit 420 performs processing such as horizontally aligning the left-view image and the right-view image and removing distortion.

### Parallax Map Acquisition Unit 430, Parallax Map Generation Engine 700

The parallax map acquisition unit 430 has a function to acquire the parallax map, generated by the parallax map generation engine 700, indicating the amount of parallax or the distance in the depth direction between the left-view image and the right-view image.

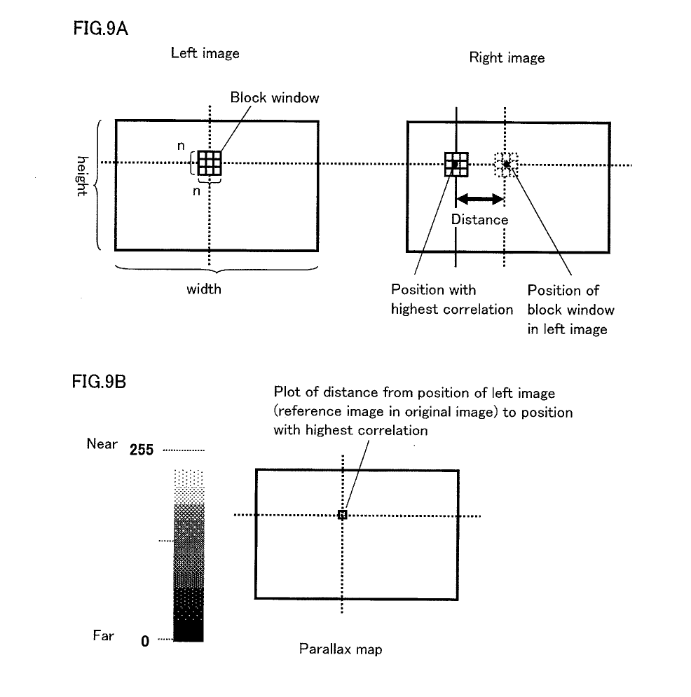

The parallax map generation engine 700 has a function to generate a parallax map from a left-view image and a right-view image. FIGS. 9A and 9B are diagrams illustrating parallax map generation. The left-view image and the right-view image are images when the same object is observed from different viewpoints. Therefore, these two images have a high correlation. Focusing on this correlation, the parallax map generation engine 700 searches in the right-view image for the pixel that corresponds to each pixel in the left-view image and calculates the parallax to be the distance between corresponding points.

FIG. 9A is a diagram illustrating the search for corresponding points during parallax map generation. As illustrated in FIG. 9A, the parallax map generation engine 700 horizontally searches the right-view image to find the pixel that corresponds to each pixel in the left-view image.

Block matching is used as the method for detecting corresponding pixels between the left-view image and the right-view image. As illustrated in FIG. 9A, in order to assess the similarity between pixels, a region of n×n pixels is extracted from each of the images being compared, and the Sum of Absolute Difference (SAD) for the difference in brightness between the regions is calculated. The displacement between the images is calculated in units of pixels by referring to the positions of extraction.

While block matching has been described as the sum of differences in brightness, block matching is not limited in this way. Instead, another method such as the Sum of Squared Difference (SSD) or the Zero-mean Normalized Cross-Correlation (ZNCC) of the difference in brightness may be used. Similarly, the method for finding corresponding positions between the left-view image and the right-view image is not limited to block matching.

Note that as the search range (the range of horizontal movement) grows larger, the required time for calculation of results increases, whereas if the range is too small, a problem occurs in that detection of the actual point with the smallest difference may not be possible. It is desirable to determine the maximum search range while taking both of these effects into consideration.

Upon detecting a pixel in the right-view image that corresponds to a pixel in the left-view image, the parallax map generation engine 700 plots the distance between the points that correspond in the left-view image and the right-view image onto the parallax map, as illustrated in FIG. 9B. In the example shown in FIG. 9B, the distance between the points that correspond in the left-view image and the right-view image is plotted after conversion to a value between 0 and 255. Performing this processing for each pixel in the left-view image allows for generation of the parallax map.

For example, consider the pixels included in the image of the man in the left-view image shown in FIG. 2. For each pixel in the image of the man in the left-view image, shifting the pixel to the right in the figure reveals the point at which the absolute difference in values between the pixel and a pixel in the right-view image is a minimum. Now consider the pixels included in the image of the sun in the left-view image shown in FIG. 2. For each pixel in the image of the sun in the left-view image, shifting the pixel to the left in the figure reveals the point at which the absolute difference in values between the pixel and a pixel in the right-view image is a minimum. The parallax map in FIG. 7 is generated by converting the values corresponding to the direction and amount of the shift to the above parallax values in a range from 0 to 255.

### Parallax Map Assessment Unit 440

The parallax map assessment unit 440 has a function to assess the accuracy of the parallax map acquired by the parallax map acquisition unit 430.

The parallax map assessment unit 440 also has a function to increase the accuracy of the parallax map by correcting the parallax map in accordance with both the accuracy of the parallax map and with the size of the display on which the stereoscopic video images, acquired from the device acquisition unit 510 described below, are shown. The parallax map assessment unit 440 determines the extent to which errors and occlusions occur in the generated parallax map and corrects the parallax map as necessary to increase the accuracy thereof. This prevents the stereoscopic video images from deteriorating upon adjustment of stereoscopic intensity due to DIBR based on pixel values with a low accuracy included in the parallax map.

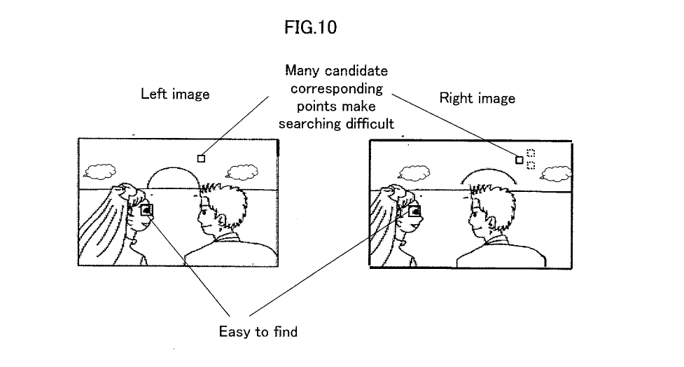

FIG. 10 is a diagram illustrating the assessment of accuracy of a parallax map. As has already been described above, the pixel that corresponds to each pixel in the left-view image is searched for in the right-view image, and the distance between the corresponding points is calculated in order to generate the parallax map. In an aspect of the present invention, the accuracy of the parallax map is assessed by focusing on the search for corresponding points during generation of the parallax map.

As illustrated in FIG. 10, in texture regions with a complex pattern, such as the woman's eye, corresponding points are easy to find. By contrast, in uniform image regions, such as the sky in the background or the man's back, many candidates for corresponding points are detected. Errors easily occur when attempting to select the correct corresponding point from among the candidates. If an erroneous corresponding point is selected, a different amount of parallax than the actual amount of parallax is calculated, and the stereoscopic intensity ends up being adjusted based on this different amount of parallax. This results in deformation of the stereoscopic video image after adjustment of the stereoscopic intensity.

To address this problem, the parallax map assessment unit 440 counts the number of pixels for which no corresponding point is detected within the maximum search range, as well as the number of pixels for which a plurality of candidate corresponding points are detected within the maximum search range, as the amount of error during the search for corresponding points when the parallax map is generated. The parallax map assessment unit 440 then assesses the accuracy of the parallax map based on the amount of error.

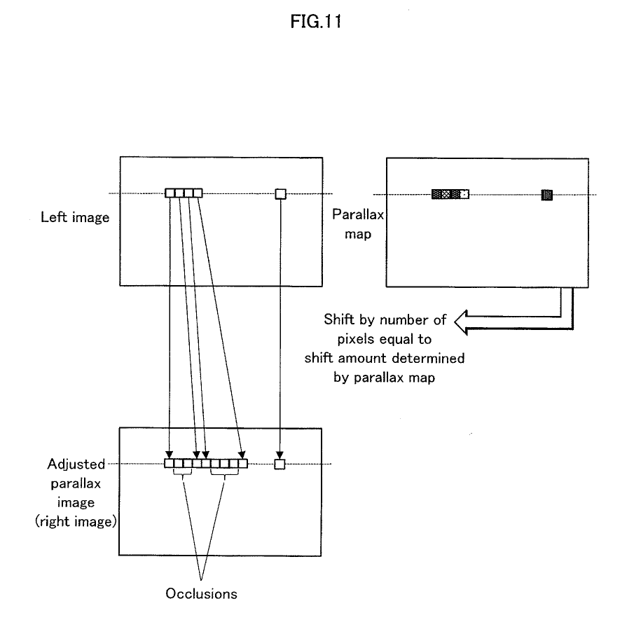

FIG. 11 is a diagram illustrating occlusions that occur during DIBR based on a parallax map. During DIBR, an adjusted parallax image (right-view image) is generated by shifting each pixel in the left-view image by a shift amount determined from the parallax map. When pixels are shifted, the shift amount for adjacent pixels may differ. If pixels are shifted with a different shift amount for adjacent pixels, a region with undefined pixel values occurs in the adjusted parallax image. Such a region with undefined pixel values in the adjusted parallax image is referred to as an occlusion.

In the example in FIG. 11, the block at the left edge of the horizontal pixel block in the left-view image is not shifted. By contrast, the adjacent block is shifted two blocks to the right. It is clear that in the adjusted parallax image, a region with undefined pixel values (occlusion) results.

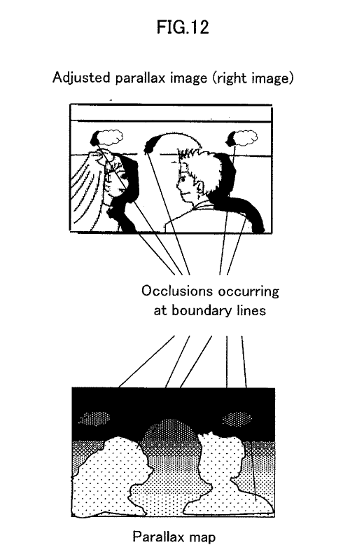

FIG. 12 is a diagram showing an example of occlusions. As illustrated in FIG. 12, occlusions occur in regions where the values of adjacent pixels in the parallax map suddenly change, i.e. near boundaries of objects included in the image. As the difference between the values of adjacent pixels in the parallax map increases, the difference in the shift amount of the pixels also increases, resulting in an increase in size of the resulting occlusion. Typically, occlusions are interpolated using surrounding pixels, but when the occlusion amount becomes excessively large, the resulting image may appear awkward to the user. Therefore, the parallax map assessment unit 440 calculates the occlusion amount occurring in the adjusted parallax image after DIBR and assesses the accuracy of the parallax map based on the calculated occlusion amount. In greater detail, the parallax map assessment unit 440 considers the occlusion amount to be the maximum value for the amount of parallax indicated the parallax map and judges the accuracy of the parallax map by comparing the maximum value for the amount of parallax with a predetermined threshold.

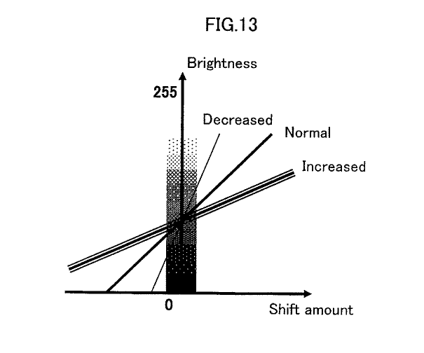

FIG. 13 is a diagram illustrating the relationship between the pixel values in a parallax map and shift amounts. A linear relationship, labeled “normal”, exists between the shift amount, calculated by searching for corresponding points between the left-view image and the right-view image, and the pixel values indicated in the parallax map.

The parallax map assessment unit 440 increases or decreases stereoscopic intensity in accordance with the size of the display on which the stereoscopic video images are shown. By changing the slope of the line in FIG. 13 indicating the relationship between the pixel values in the parallax map and the shift amount, the parallax map assessment unit 440 converts the shift amount indicated by the parallax map.

In order to increase the stereoscopic intensity, the parallax map assessment unit 440 switches the relationship between the shift amount and the pixel values in the parallax map to the line labeled “increased”. By doing so, the pixel values indicated in the parallax map can be converted to a larger shift amount than normal.

On the other hand, in order to decrease the stereoscopic intensity, the parallax map assessment unit 440 switches the relationship between the shift amount and the pixel values in the parallax map to the line labeled “decreased”. By doing so, the pixel values indicated in the parallax map can be converted to a smaller shift amount than normal.

### Parallax Map Adjustment Unit 450

The parallax map adjustment unit 450 has a function to adjust the amount of parallax indicated in a parallax map in accordance with parallax information stored in the parallax information storage memory 600. Specifically, the parallax map adjustment unit 450 compares the maximum value for the amount of parallax in the parallax map with the upper limit on the amount of parallax indicated in the parallax information. If the maximum value for the amount of parallax in the parallax map exceeds the upper limit on the amount of parallax indicated in the parallax information, the parallax map adjustment unit 450 changes the amount of parallax indicated by the parallax map so that the maximum value for the amount of parallax in the parallax map does not exceed the upper limit on the amount of parallax indicated in the parallax information. The parallax map adjustment unit 450 changes the amount of parallax by switching the slope of the line in FIG. 13 indicating the relationship between the pixel values in the parallax map and the amount of parallax.

### DIBR Execution Unit 460

The DIBR execution unit 460 has a function to generate an adjusted parallax image (right-view image) by shifting the coordinates of each pixel in the left-view image with reference to the parallax map output by the parallax map adjustment unit 450.

### Display Control Module 500

The display control module 500 includes the device information acquisition unit 510 and the output setting unit 520 and has a function to control display of the stereoscopic video images.

### Device Information Acquisition Unit 510

The device information acquisition unit 510 has a function to acquire device information such as information on display performance, including the size of the display on which the stereoscopic video images are shown, the resolution of the display, 2D/3D support, and the like.

### Output Setting Unit 520

The output setting unit 520 has a function to select a setting for the output switch 1300, described below, indicating one of the following types of output: (1) 2D output by outputting one plane only once, (2) performing 3D output that looks like 2D output by outputting the same plane twice, once for the left view and once for the right view, and (3) performing 3D output by outputting two planes respectively as the left view and the right view.

### Rendering Engine 800

The rendering engine 800 has a function to write the right-view image and the left-view image, for which the stereoscopic intensity control module 400 has adjusted the stereoscopic intensity, to the left-view plane 1100 and the right-view plane 1200.

### Image Memory 900

The image memory 900 has a function to store image data for the left-view images and the right-view images that constitute stereoscopic video images.

### Image Decoder 1000

The image decoder 1000 has a function to decode image data stored in the image memory 900.

### Left-View Plane 1100, Right-View Plane 1200

The left-view plane 1100 has a function to store the left-view image output by the image memory 900 or the image for which the stereoscopic intensity control module 400 has adjusted the stereoscopic intensity. The right-view plane 1200 has a function to store the right-view image output by the image memory 900 or the image for which the stereoscopic intensity control module 400 has adjusted the stereoscopic intensity.

### Output Switch 1300

The output switch 1300 has a function to switch output of the information stored in the left-view plane 1100 and the right-view plane 1200 in accordance with the setting by the output unit 520.

This concludes the description of the structure of the stereoscopic intensity adjustment device 10. Next, the operations of the stereoscopic intensity adjustment device 10 with the above structure are described.

### Operations of the Stereoscopic Intensity Adjustment Device According to Embodiment 1

### Stereoscopic Intensity Adjustment

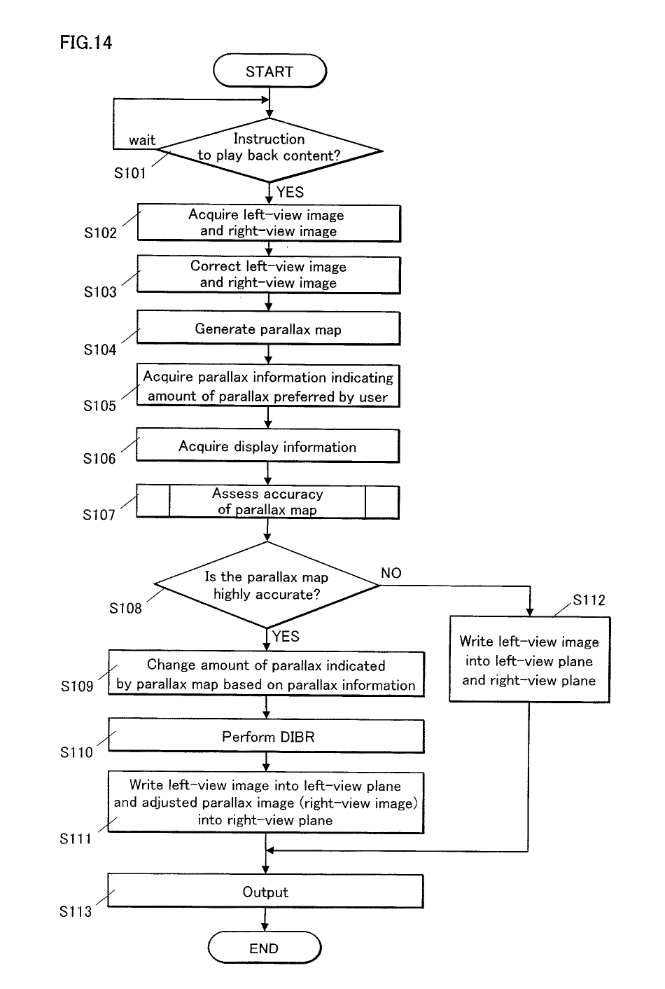

FIG. 14 is a flowchart illustrating the flow of stereoscopic intensity adjustment by the stereoscopic intensity adjustment device 10.

As illustrated in FIG. 14, the content playback module 200 determines whether an instruction to play back content has been received from the user (step S101).

If no instruction to play back content has been received, the content playback module 200 waits until reception of a playback instruction. If an instruction to play back content has been received (step S101, YES), the content playback module 200 instructs the stereoscopic intensity control module 400 to play back the content. The left/right image acquisition unit 410 of the stereoscopic intensity control module 400 acquires the left-view image and the right-view image, as instructed by the content playback module 200, from among image data stored in the image memory 900 (step S102).

After the left/right image acquisition unit 410 acquires the left-view image and the right-view image, the image correction unit 420 corrects the acquired left-view image and right-view image (step S103). Specifically, the image correction unit 420 performs processing such as horizontally aligning the left-view image and the right-view image and removing distortion in order to facilitate generation of the parallax map.

After adjustment of the left-view image and the right-view image, the parallax map generation engine 700 generates the parallax map from the corrected left-view image and right-view image. The parallax map acquisition unit 430 then acquires the parallax map generated by the parallax map generation engine 700 (step S104). Parallax is calculated by searching in the right-view image for the pixel that corresponds to each pixel in the left-view image and calculating the distance between the corresponding points.

After generation of the parallax map, the parallax map adjustment unit 450 acquires parallax information indicating the amount of parallax permitted by the user and stored in the parallax information storage memory 600 (S105).

After acquisition of the parallax information, the device information acquisition unit 510 in the control module 500 acquires device information for the display on which stereoscopic video images are shown (step S106).

After acquisition of the device information for the display, the parallax map assessment unit 440 assesses the accuracy of the parallax map (step S107). The details on the assessment of accuracy of the parallax map are provided below.

After assessment of the accuracy of the parallax map, the stereoscopic intensity control module 400 determines whether the parallax map assessment unit 440 has assessed the parallax map as having a high accuracy (step S108).

If the accuracy of the parallax map has been assessed as high (step S108, YES), the parallax map adjustment unit 450 changes the amount of parallax indicated by the parallax map based on the parallax information indicating the upper limit on the amount of parallax (step S109). Specifically, as illustrated in FIG. 13, the parallax map adjustment unit 450 changes the amount of parallax indicated by the parallax map so as to satisfy the upper limit on the amount of parallax indicated in the parallax information by switching the slope of the line indicating the relationship between the pixel values in the parallax map and the amount of parallax.

After the amount of parallax indicated in the parallax map has changed, the DIBR execution unit 460 performs DIBR based on the amount of parallax indicated in the changed parallax map (step S110). Specifically, the DIBR execution unit 460 generates an adjusted parallax image (right-view image) by shifting the coordinates of each pixel in the left-view image by the number of pixels corresponding to the amount of parallax indicated in the changed parallax map.

After DIBR processing, the rendering engine 800 writes the left-view image into the left-view plane 1100 and writes the right-view image into the right-view plane 1200 (step 111).

If the accuracy of the parallax map has been assessed as low (step S108, NO), the rendering engine 800 writes the left-view image in both the left-view plane 1100 and the right-view plane 1200 (step S112).

After writing of images in the left-view plane 1100 and the right-view plane 1200, the stereoscopic intensity adjustment device 10 outputs the images stored in the planes (step S113).

This concludes the description of the structure of stereoscopic intensity adjustment by the stereoscopic intensity adjustment device 10. Next, the assessment of accuracy of the parallax map in step S107 is described in detail.

### Assessment of Accuracy of Parallax Map

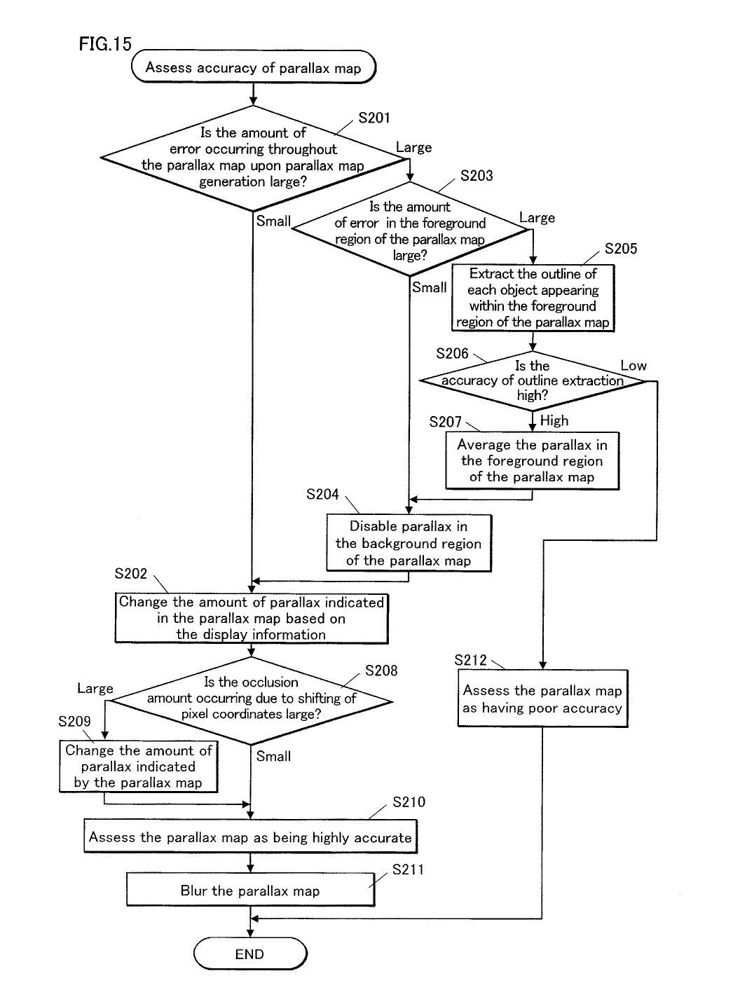

FIG. 15 is a flowchart illustrating the flow of assessment of accuracy of the parallax map.

As illustrated in FIG. 15, the parallax map assessment unit 440 determines whether a large amount of error occurs throughout the parallax map upon parallax map generation (step S201). The amount of error referred to here is the number of pixels, during the search for corresponding points when the parallax map is generated, for which no corresponding point is detected within the maximum search range as well as the number of pixels, during the search, for which a plurality of candidate corresponding points are detected within the maximum search range. The magnitude of the amount of error is determined by comparing the amount of error throughout the parallax map with a predetermined threshold. If the amount of error is at least the predetermined threshold, the parallax map assessment unit 440 determines that the amount of error throughout the parallax map is large. If the amount of error is less than the predetermined threshold, the parallax map assessment unit 440 determines that the amount of error throughout the parallax map is small.

If the amount of error throughout the parallax map is small (step S201, NO), the parallax map assessment unit 440 changes the amount of parallax indicated by the parallax map to be a value appropriate for the display on which the stereoscopic video images are shown based on the size of the display (step S202).

Changing the amount of parallax to an appropriate value refers, for example, to changing the amount of parallax so that the amount by which images project or recede is based on a parallax angle of one degree. This allows for the provision of stereoscopic video images that cause little visual fatigue or sense of awkwardness for the user.

If the upper limit of the parallax angle is provided, the upper limit on the amount of parallax can be calculated using the above Equations 7 and 8. So as to satisfy the upper limit on the calculated amount of parallax, the slope of the line in FIG. 13 indicating the relationship between the pixel values in the parallax map and the amount of parallax is switched.

Alternatively, the parallax map assessment unit 440 may change the amount of parallax so that the ratio between the distance from the viewing position to the display and the maximum amount by which images project or recede becomes a predetermined fixed value. Stereoscopic video images with a stereoscopic intensity appropriate for the size of the screen on which the stereoscopic video images are shown can thus be provided.

Typically, the most appropriate viewing distance is considered to be three times the height of the display. Therefore, the distance from the viewing position to the display can be calculated by multiplying the height of the display by three.

In this case, the upper limit on the amount of parallax is calculated based on Equation 6 above, and so as to satisfy the calculated upper limit on the calculated amount of parallax, the slope of the line in FIG. 13 indicating the relationship between the pixel values in the parallax map and the amount of parallax is switched.

If the amount of error throughout the parallax map is large (step S201, YES), the parallax map assessment unit 440 divides the parallax map into a foreground region and a background region and determines whether the amount of error in the foreground region is large (step S203).

The parallax map assessment unit 440 considers the region whose pixel values in the parallax map are larger than a predetermined threshold to be the foreground region and considers the region whose pixel values in the parallax map are smaller than a predetermined threshold to be the background region. Appropriately adjusting these thresholds allows for the portion shown behind the display to become the background region and the portion shown in front of the display to become the foreground region.

The magnitude of the amount of error is determined by comparing the amount of error in the foreground region of the parallax map with a predetermined threshold. If the amount of error is at least the predetermined threshold, the parallax map assessment unit 440 determines that the amount of error in the foreground region of the parallax map is large. If the amount of error is less than the predetermined threshold, the parallax map assessment unit 440 determines that the amount of error in the foreground region of the parallax map is small.

If the amount of error in the foreground region of the parallax map is small (step S203, NO), the parallax map assessment unit 440 invalidates parallax in the background region of the parallax map (step S204). Specifically, the parallax map assessment unit 440 changes the pixel values of the background region to values corresponding to the position that recedes the furthest back from the display. Invalidating the background region of a parallax map with a large amount of error increases the accuracy of the parallax map.

If the amount of error in the foreground region of the parallax map is large (step S204, YES), the parallax map assessment unit 440 extracts the outline of each object appearing in the left-view image within the foreground region of the parallax map (step S205).

After extracting the outline of each object, the parallax map assessment unit 440 determines whether the outline of each object is highly accurate (step S206). Specifically, the parallax map assessment unit 440 refers to the pixel values in the parallax map corresponding to the pixels constituting the extracted outline and determines that the outline is highly accurate if fluctuation of the pixel values is less than a pre-stored threshold.

If the outline is highly accurate (step S206, YES), the parallax map assessment unit 440 averages the parallax in the foreground region of the parallax map (step S207). Averaging the foreground region of a parallax map with a large amount of error increases the accuracy of the parallax map. Furthermore, a decrease in the accuracy of the parallax map due to averaging of the amount of parallax in the foreground region of the parallax map is avoided, since the amount of parallax in the foreground region of the parallax map is averaged under the condition that the accuracy of the outline extracted for each object in the foreground region be at least a predetermined accuracy.

After the amount of parallax is changed based on the size of the display on which the stereoscopic video images are shown, the parallax map assessment unit 440 determines whether the occlusion amount due to shifting of the pixel coordinates during DIBR is large (step S208).

Specifically, the parallax map assessment unit 440 first acquires the largest pixel value in the parallax map and then checks on the shift amount corresponding to the largest pixel value. The parallax map assessment unit 440 identifies the shift amount corresponding to the maximum pixel value in the parallax map by referring to the lines in FIG. 13 indicating the relationship between the pixel values in the parallax map and the shift amounts. The identified shift amount represents the maximum occlusion in the parallax map. The parallax map assessment unit 440 compares the maximum occlusion with a predetermined threshold and determines that the occlusion amount is large if the occlusion amount exceeds the predetermined threshold. If the occlusion amount is less than the predetermined threshold, the parallax map assessment unit 440 determines that the occlusion amount is small.

The above predetermined threshold may, for example, be the number of pixels corresponding to a parallax angle of one degree as recommended by the 3D Consortium for comfortable viewing of stereoscopic video images.

It may also be determined whether the occlusion amount is large, i.e. whether the parallax map is highly accurate, by calculating the parallax angle from the shift amount corresponding to the maximum pixel value included in the parallax map and comparing the calculated parallax angle with a predetermined threshold parallax angle.

If the occlusion amount is large (step S208, YES), the parallax map assessment unit 440 changes the maximum parallax in the parallax map to be within a threshold for the occlusion amount (step S209). Specifically, the parallax map assessment unit 440 switches the slope of the line in FIG. 13 indicating the relationship between the pixel values in the parallax map and the amount of parallax, so that the shift amount for the maximum pixel value included in the parallax map is equal to or less than the above threshold. Adjustment of stereoscopic intensity can reduce the occlusion amount, thereby reducing the sense of awkwardness due to occlusions.

Note that when the slope of the line has already been changed during step S202, it is necessary to change the slope of the line within a range satisfying the conditions of the processing in step S202.

Changing the slope of the line indicating the relationship between the pixel values in the parallax map and the shift amounts allows for a reduction in the shift amount corresponding to the maximum pixel value included in the parallax map. The shift value also decreases for the pixel values other than the maximum pixel value included the parallax map in proportion to the change in the maximum pixel value.

After steps S208 and S209, the parallax map assessment unit 440 assesses the parallax map as being highly accurate (step S210).

After assessment of the parallax map, the parallax map assessment unit 440 blurs the entire parallax map (step S211). Occlusions occur in regions where the values of adjacent pixels in the parallax map suddenly change. By blurring the parallax map, the changes in the pixel values of the parallax map become smooth, thus moderating the occlusion amount occurring due to DIBR.

If the outline has poor accuracy (step S206, NO), the parallax map assessment unit 440 assesses the parallax map as having poor accuracy (step S212).

Note that when the background region and the foreground region cannot be separated in the above processing, the parallax map may be assessed as having poor accuracy.

Furthermore, an example of assessing the accuracy of the parallax map based on the amount of error in the foreground region and the accuracy of outlines in the foreground region during the above processing has been described, the accuracy of the parallax map may instead be assessed based on the amount of error in the background region and the accuracy of outlines in the background region.

As described above, the present embodiment allows for improvement of the accuracy of the parallax map by changing the parallax map based on the size of the display and the accuracy of the parallax map. This allows for stereoscopic adjustment that yields an even more natural appearance, thus alleviating eyestrain and offering viewers a more realistic experience.

### Embodiment 2

Like the stereoscopic intensity adjustment device 10 according to Embodiment 1, a stereoscopic intensity adjustment device according to Embodiment 2 adjusts stereoscopic intensity by changing the amount of parallax in the parallax map with reference to the accuracy of the parallax map and the display size. The stereoscopic intensity adjustment device according to Embodiment 2 differs, however, by switching the method of adjusting stereoscopic intensity in accordance with the accuracy of the parallax map. In accordance with the accuracy of the parallax map, the stereoscopic intensity adjustment device according to Embodiment 2 selects either a stereoscopic intensity adjustment unit based on DIBR that uses the parallax map or a stereoscopic intensity adjustment unit based on plane shifting that does not use the parallax map. This prevents deformation of the stereoscopic video images due to the stereoscopic intensity being adjusted based on a miscalculated parallax. The resulting adjustment of stereoscopic intensity thus appears highly natural to viewers.

### Structure of Stereoscopic Intensity Adjustment Device According to Embodiment 2

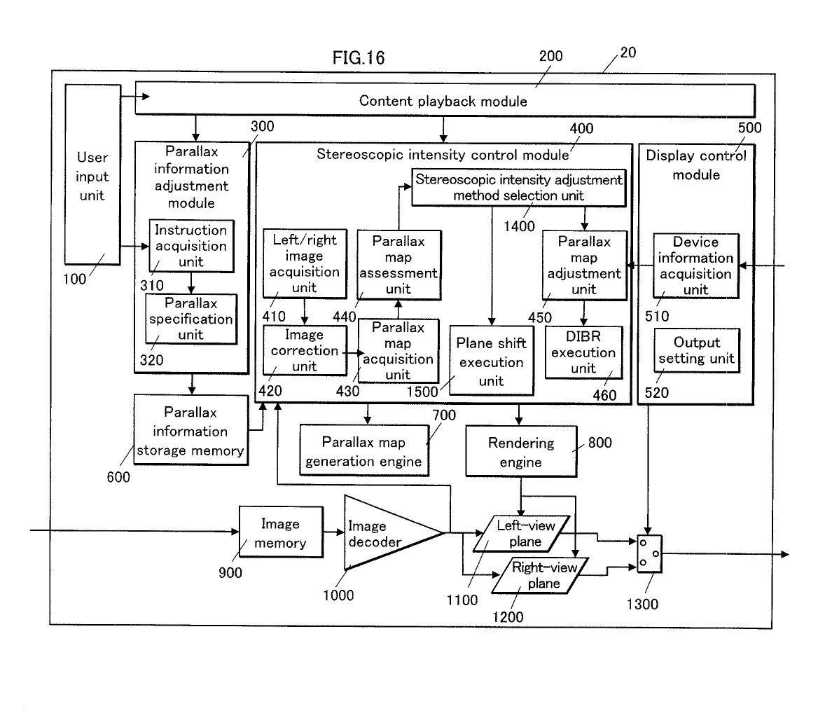

FIG. 16 is a block diagram illustrating an example of the structure of a stereoscopic intensity adjustment device 20 according to Embodiment 2. As shown in FIG. 16, the stereoscopic intensity adjustment device 20 includes a user input unit 100, a content playback module 200, a parallax information adjustment module 300, a stereoscopic intensity control module 400, a display control module 500, a parallax information storage memory 600, a parallax map generation engine 700, a rendering engine 800, an image memory 900, an image decoder 1000, a left-view plane 1100, a right-view plane 1200, and an output switch 1300. The parallax information adjustment module 300 includes an instruction acquisition unit 310 and a parallax specification unit 320. The stereoscopic intensity control module 400 includes a left/right image acquisition unit 410, an image correction unit 420, a parallax map acquisition unit 430, a parallax map assessment unit 440, a stereoscopic intensity adjustment method selection unit 1400, a parallax map adjustment unit 450, a DIBR execution unit 460, and a plane shift execution unit 1500. The display control module 500 includes a device information acquisition unit 510 and an output setting unit 520. Components that are the same as the stereoscopic intensity adjustment device 10 according to Embodiment 1 are provided with the same labels, and a description thereof is omitted. Below, structural differences from the stereoscopic intensity adjustment device 10 are described.

### Stereoscopic Intensity Adjustment Method Selection Unit 1400

The stereoscopic intensity adjustment method selection unit 1400 has a function to select the method for adjusting stereoscopic intensity in accordance with the assessment of the accuracy of the parallax map. Specifically, when the parallax map is assessed as being highly accurate, the stereoscopic intensity adjustment method selection unit 1400 selects adjustment of stereoscopic intensity based on DIBR that uses the parallax map and issues an instruction to perform DIBR to the parallax map adjustment unit 450 and the DIBR execution unit 460. When the parallax map is assessed as having poor accuracy, the stereoscopic intensity adjustment method selection unit 1400 selects adjustment of stereoscopic intensity based on plane shifting that does not use the parallax map and issues an instruction to perform plane shifting to the plane shift execution unit 1500 described below.

### Plane Shift Execution Unit 1500

The plane shift execution unit 1500 has a function to perform plane shifting on the left-view image and the right-view image. Plane shifting is technology for adjusting stereoscopic intensity by uniformly shifting the left-view image and the right-view image to the left or the right.

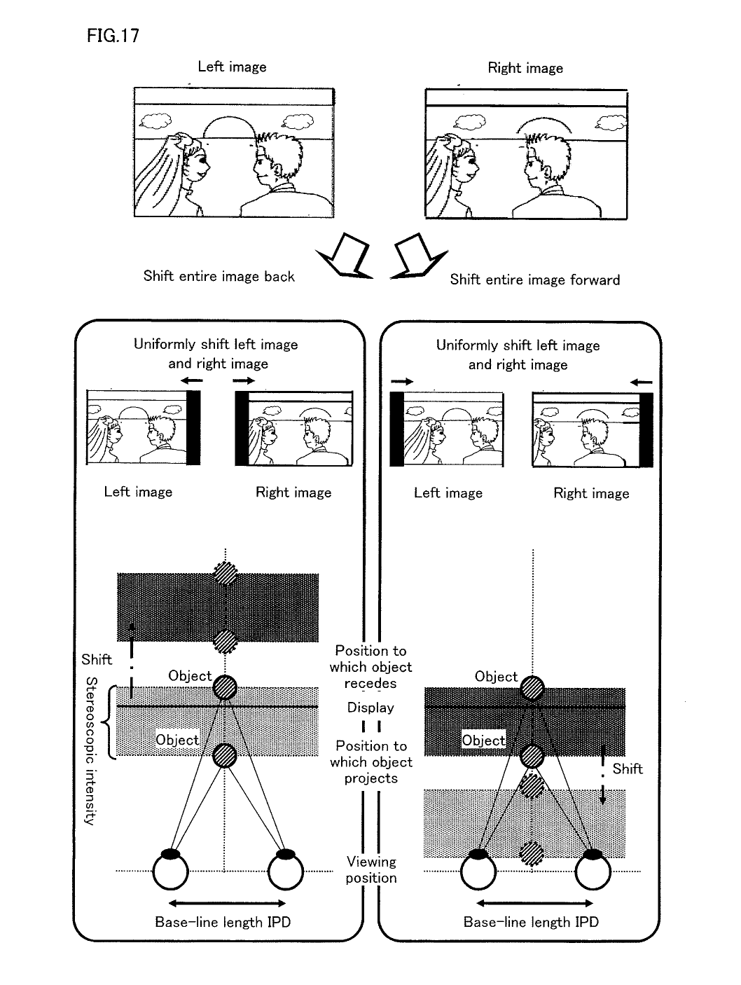

FIG. 17 is a diagram outlining plane shifting. As illustrated in FIG. 17, during plane shifting to increase the stereoscopic intensity of the stereoscopic video images, the left-view image is shifted to the left and the right-view image is shifted to the right by a uniform number of pixels. Shifting the left-view image and the right-view image outwards by a uniform number of pixels allows for the position to which an object being viewed projects or recedes to be uniformly shifted away from the viewing position.

During plane shifting to decrease the stereoscopic intensity of the stereoscopic video images, the left-view image is shifted to the right and the right-view image is shifted to the left by a uniform number of pixels. Shifting the left-view image and the right-view image inwards by a uniform number of pixels allows for the position to which an object being viewed projects or recedes to be uniformly shifted towards the viewing position.

Note that the portion that extends past the screen due to uniformly shifting pixels is cut off. Furthermore, a region with no pixel values yielded by uniformly shifting pixels is made transparent.

This concludes the description of the structure of the stereoscopic intensity adjustment device 20. Next, the operations of the stereoscopic intensity adjustment device 20 with the above structure are described.

### Operations of the Stereoscopic Intensity Adjustment Device According to Embodiment 2

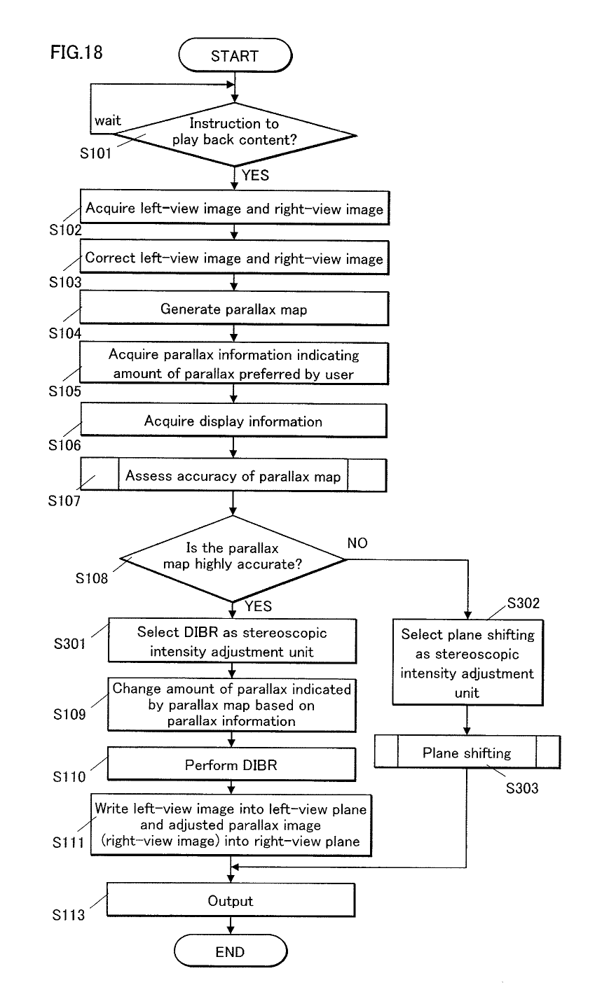

FIG. 18 is a flowchart illustrating the flow of stereoscopic intensity adjustment by the stereoscopic intensity adjustment device 20. Processing steps that are the same as the stereoscopic intensity adjustment according to Embodiment 1 are provided with the same labels, and a description thereof is omitted.

As illustrated in FIG. 18, steps S301, S302, and S303 differ from the stereoscopic intensity adjustment according to Embodiment 1.

After assessment of accuracy of the parallax map in step S107, it is determined in step S108 whether the parallax map is highly accurate.

In other words, when the parallax map is assessed as being highly accurate in step S210, the parallax map is determined to be highly accurate in step S108. Furthermore, when the parallax map is assessed as having poor accuracy in step S212, the parallax map is determined to have poor accuracy in step S108.

While the accuracy of the parallax map is determined above based on the amount of error occurring when searching for corresponding points and on the stereoscopic intensity of the stereoscopic video images yielded by the value of the parallax indicated in the parallax map, the accuracy of the parallax map may instead be determined based only on the stereoscopic intensity of the stereoscopic video images yielded by the value of the parallax indicated in the parallax map. In this case, when the shift amount for the maximum pixel value included in the parallax map is larger than a predetermined threshold (step S208, YES), the parallax map is assessed as having poor accuracy, whereas when the shift amount for the maximum pixel value included in the parallax map is less than a predetermined threshold (step S208, NO), the parallax map is assessed as being highly accurate.

Alternatively, the accuracy of the parallax map may be determined using only the amount of error occurring when searching for corresponding points. In this case, when the amount of error occurring when searching for corresponding points is larger than a predetermined threshold (step S201, YES), the parallax map is assessed as having poor accuracy, whereas when the amount of error occurring when searching for corresponding points is smaller than a predetermined threshold (step S201, NO), the parallax map is assessed as being highly accurate.

After step S108, when the accuracy of the parallax map is assessed as being high (step S108, YES), the stereoscopic intensity adjustment method selection unit 1400 selects DIBR as the method of stereoscopic intensity adjustment (step S301). Specifically, the stereoscopic intensity adjustment method selection unit 1400 issues an instruction to perform DIBR to the parallax map adjustment unit 450 and the DIBR execution unit 460. The parallax map adjustment unit 450 and the DIBR execution unit 460 receive the instruction from the stereoscopic intensity adjustment method selection unit and perform the processing from step S109 through step S111.

When the parallax map is assessed as having low accuracy (step S108, NO), the stereoscopic intensity adjustment method selection unit 1400 selects plane shifting as the stereoscopic intensity adjustment method (step S302). Specifically, the stereoscopic intensity adjustment method selection unit 1400 issues an instruction to perform plane shifting to the plane shift execution unit 1500.

The plane shift execution unit 1500 receives the instruction from the stereoscopic intensity adjustment method selection unit 1400 and performs plane shifting (step S303). Details on plane shifting are provided below.

As described above, the amount of error occurring when searching for corresponding points is detected. When the amount of error is greater than a predetermined threshold, stereoscopic intensity is adjusted by plane shifting, whereas when the amount of error is less than the predetermined threshold, stereoscopic intensity is adjusted with DIBR. This prevents a degradation in quality of the stereoscopic video images after adjustment of the stereoscopic intensity due to erroneous detection when searching for corresponding points.

Furthermore, the largest shift amount indicated by the parallax map is detected. When the largest shift amount is greater than a predetermined threshold, stereoscopic intensity is adjusted by DIBR, whereas when the largest detected shift amount is smaller than a predetermined threshold, plane shifting is performed.

Since plane shifting adjusts stereoscopic intensity by uniformly shifting the left-view image and the right-view image to the left or right, plane shifting is unable to adjust the sense of depth whereby the stereoscopic video images appear to project or recede. Plane shifting does have the advantages, however, that (1) no occlusion occurs in the image after adjustment of stereoscopic intensity, and (2) the image after stereoscopic adjustment does not deform due to corresponding points erroneously detected during generation of the parallax map.

On the other hand, during DIBR, the coordinates of each pixel are shifted by a different number of pixels for each pixel indicated in the parallax map, leading to the risk of deformation of the image after stereoscopic adjustment due to corresponding points erroneously detected during generation of the parallax map. DIBR does, however, allow for adjustment of the sense of depth whereby the stereoscopic video images appear to project or recede.

When the stereoscopic intensity of the stereoscopic video images is within an appropriate range, major adjustment of the stereoscopic intensity is unnecessary. Therefore, adjusting the stereoscopic intensity with plane shifting is possible without causing the quality of the stereoscopic images to degrade. On the other hand, when the stereoscopic intensity of the stereoscopic video images exceeds an appropriate intensity, it becomes necessary to change the stereoscopic intensity to be within an appropriate level. Therefore, adjusting the stereoscopic intensity with DIBR allows for adjustment of the sense of depth whereby the stereoscopic video images appear to project or recede.

This concludes the description of the structure of stereoscopic intensity adjustment by the stereoscopic intensity adjustment device 20. Next, details on the plane shifting in step S303 are provided.

### Plane Shifting

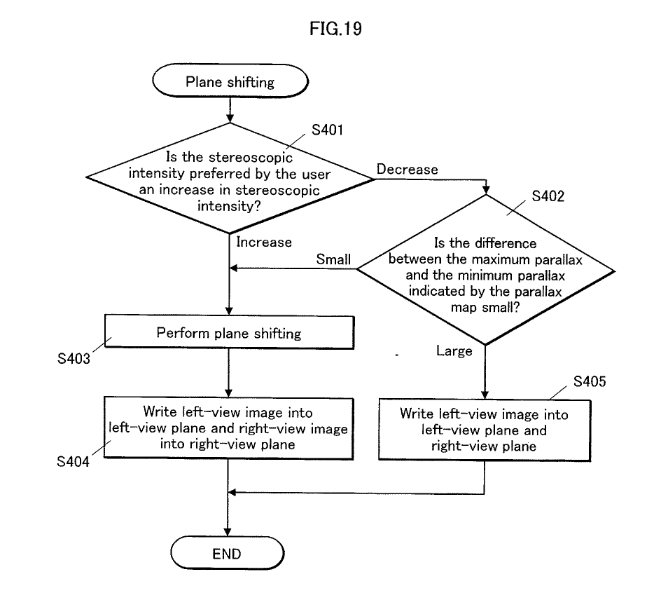

FIG. 19 is a flowchart showing the flow of plane shifting.

As illustrated in FIG. 19, the plane shift execution unit 1500 first determines whether it is necessary to increase or decrease the stereoscopic intensity when outputting the left-view image and the right-view image (step S401). Specifically, the plane shift execution unit 1500 determines whether to increase or decrease the stereoscopic intensity by referring to the stereoscopic intensity preferred by the user as input via the user input unit 100. Alternatively, the plane shift execution unit 1500 may determine whether to increase or decrease the stereoscopic intensity by comparing the stereoscopic information generated by the parallax information adjustment module 300 with the maximum parallax indicated in the parallax map.

When decreasing stereoscopic intensity (step S401, NO), the plane shift execution unit 1500 determines whether the difference between the maximum parallax and the minimum parallax indicated by the parallax map is small (step S402).

When increasing stereoscopic intensity (step S401, YES), or when the difference between the maximum parallax and the minimum parallax indicated by the parallax map is small (step S402, YES), the plane shift execution unit 1500 performs a plane shift on the left-view image and the right-view image (step S403).

After plane shifting, the plane shift execution unit 1500 instructs the rendering engine 800 to write the left-view image into the left-view plane 1100 and to write the right-view image into the right-view plane 1200 (step S404).

When the difference between the maximum parallax and the minimum parallax indicated by the parallax map is large (step S402, NO), the plane shift execution unit 1500 does not perforin plane shifting, but rather simply instructs the rendering engine 800 to write the left-view image into the left-view plane 1100 and to write the right-view image into the right-view plane 1200 (step S405).

In the case of receding stereoscopy, if the parallax exceeds the interpupillary distance IPD of the user, the line of sight for the left eye and the line of sight for the right eye are caused to diverge, which leads to eyestrain. When the difference between the maximum parallax and the minimum parallax indicated in the parallax map is large and the formed image is moved even further back, this sort of situation may occur. Therefore, in the present processing, plane shifting is not performed when, in the case of determining to decrease the stereoscopic intensity, the difference between the maximum parallax and the minimum parallax indicated in the parallax map is large.

As described above, in the present embodiment, the accuracy of the parallax map that indicates the parallax of the stereoscopic video images is determined, and in accordance with the determined accuracy, either a stereoscopic intensity adjustment unit that performs a pixel shift with reference to the parallax map or a stereoscopic intensity adjustment unit that performs a plane shift without reference to the parallax map is selected. The present embodiment thus reduces deformation of the stereoscopic video images due to adjustment of stereoscopic intensity.

### Supplementary Explanation

During the above stereoscopic intensity adjustment, the user may be asked to judge whether the stereoscopic video images after stereoscopic intensity adjustment are appropriate.

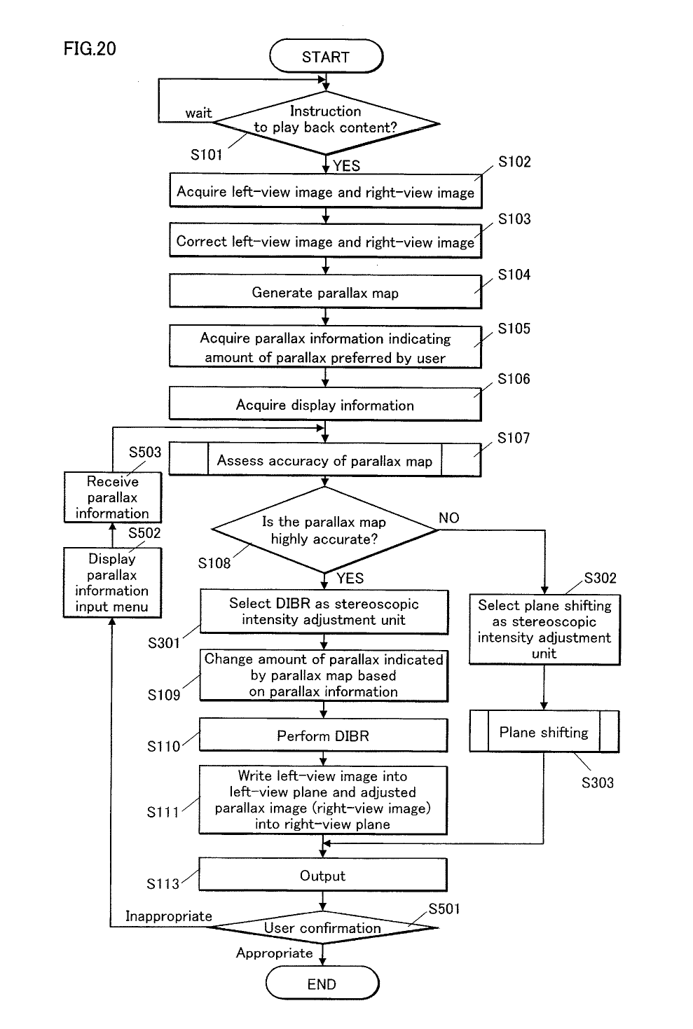

FIG. 20 is a flowchart illustrating the flow of stereoscopic intensity adjustment that includes confirmation of whether the adjustment of stereoscopic intensity is appropriate. Processing steps that are the same as the stereoscopic intensity adjustment illustrated in FIG. 18 are provided with the same labels, and a description thereof is omitted.

As illustrated in FIG. 20, steps S501, S502, and S503 differ from the stereoscopic intensity adjustment illustrated in FIG. 18.

After the output in step S113 of images stored in the plane, the user input unit 100 requests user confirmation of whether the stereoscopic intensity of the stereoscopic video images is appropriate (step S501). For example, the user input unit 100 requests user confirmation by displaying a menu screen to the user and receiving a user operation in response to the menu screen.

If the input indicates that the stereoscopic intensity of the stereoscopic video images is appropriate (step S501, YES), the stereoscopic intensity adjustment device 20 terminates stereoscopic intensity adjustment.

If the input indicates that the stereoscopic intensity of the stereoscopic video images is not appropriate (step S501, NO), the user input unit 100 displays a parallax information input menu and requests that the user input a parameter indicating a preferred stereoscopic intensity (step S502).

After display of the parallax information input menu, the user input unit 100 receives the parameter indicating the stereoscopic intensity, converts the input parameter into parallax information via the parallax information adjustment module 300, and stores the parallax information in the parallax information storage memory 600 (step S503).

After step S503, processing subsequent to step S107 is performed, such as assessment of the accuracy of the parallax map and adjustment of the stereoscopic intensity.

In this way, the stereoscopic adjustment device can further reflect user preference for images that are automatically adjusted and displayed.

### Embodiment 3

Like the stereoscopic intensity adjustment device 10 according to Embodiment 1, a stereoscopic intensity adjustment device according to Embodiment 3 adjusts stereoscopic intensity by changing the amount of parallax in the parallax map with reference to the accuracy of the parallax map and the display size. The stereoscopic intensity adjustment device according to Embodiment 3 differs, however, by reacquiring the parallax map with a different method than the method previously used to generate the parallax map in the case that the parallax map is assessed as having poor accuracy.

### Structure of Stereoscopic Intensity Adjustment Device According to Embodiment 3

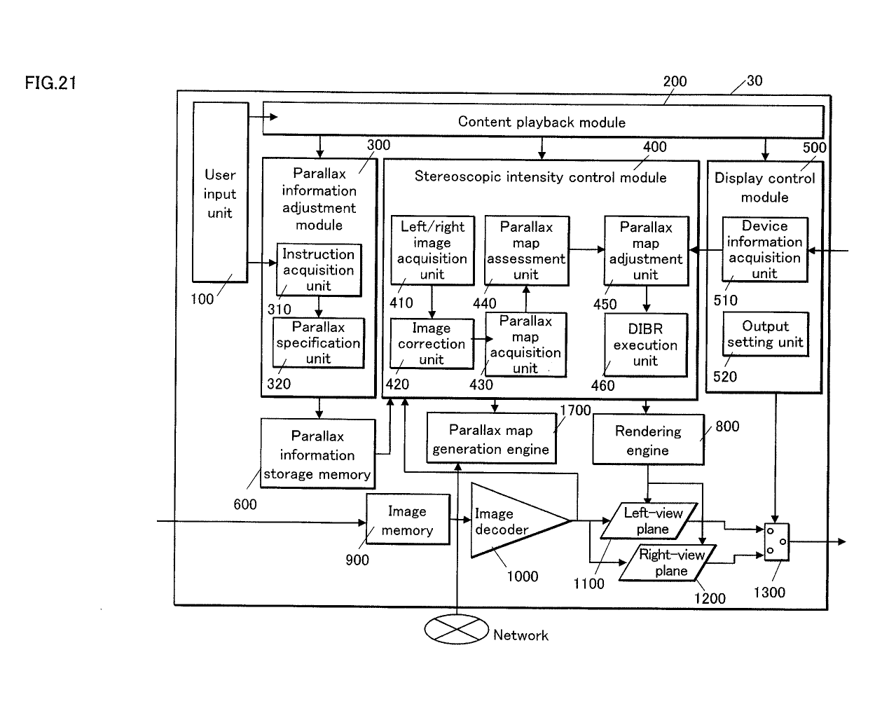

FIG. 21 is a block diagram illustrating an example of the structure of a stereoscopic intensity adjustment device 30 according to Embodiment 3. As shown in FIG. 21, the stereoscopic intensity adjustment device 30 includes a user input unit 100, a content playback module 200, a parallax information adjustment module 300, a stereoscopic intensity control module 400, a display control module 500, a parallax information storage memory 600, a parallax map generation engine 1700, a rendering engine 800, an image memory 900, an image decoder 1000, a left-view plane 1100, a right-view plane 1200, and an output switch 1300. The parallax information adjustment module 300 includes an instruction acquisition unit 310 and a parallax specification unit 320. The stereoscopic intensity control module 400 includes a left/right image acquisition unit 410, an image correction unit 420, a parallax map acquisition unit 1600, a parallax map assessment unit 440, a parallax map adjustment unit 450, and a DIBR execution unit 460. The display control module 500 includes a device information acquisition unit 510 and an output setting unit 520. Components that are the same as the stereoscopic intensity adjustment device 10 according to Embodiment 1 are provided with the same labels, and a description thereof is omitted. Below, structural differences from the stereoscopic intensity adjustment device 10 are described.

### Parallax Map Acquisition Unit 1600

The parallax map acquisition unit 1600 has a function to acquire the parallax map, generated by the parallax map generation engine 1700, indicating the amount of parallax or the distance in the depth direction between the left-view image and the right-view image. The parallax map acquisition unit 1600 also has a function to request that the parallax map generation engine 1700 generate a parallax map with a different method than the previous method for generating the parallax map when the acquired parallax map is assessed as having poor accuracy.

### Parallax Map Generation Engine 1700

The parallax map generation engine 1700 has a function to generate a parallax map in response to a request from the parallax map acquisition unit 1600. When requested to regenerate the parallax map, the parallax map generation engine 1700 generates the parallax map using a different method than the previous method for generating the parallax map.

When parallax was previously calculated by searching in the right-view image for the pixel that corresponds to each pixel in the left-view image and calculating the distance between the corresponding points, the parallax map generation engine 1700 for example regenerates the parallax map by downloading, over a network, a parallax map corresponding to the left-view image and the right-view image.

In order to regenerate the parallax map, the parallax map generation engine 1700 may also recalculate the parallax after changing the parameters for calculating the parallax. The parameters for calculating the parallax may be the size of the parallax map, the maximum search range when searching for corresponding points, or the like. The parallax map generation engine 1700 recalculates the parallax by changing these parameters.

The parallax map generation engine 1700 may also regenerate the parallax map by calculating the parallax with a different algorithm. Algorithms for calculating the parallax include the following: (1) the method described with reference to FIG. 9, (2) a method that searches for corresponding points taking into consideration conformity in the vertical and diagonal directions as well, unlike the method illustrated in FIG. 9 that searches for corresponding points only in the horizontal direction, (3) a method to generate parallax based on color and brightness of pixels, and (4) a method to generate parallax based on graph theory. The parallax map generation engine 1700 recalculates the parallax by selecting a different one of these algorithms for calculating parallax.

This concludes the description of the structure of the stereoscopic intensity adjustment device 30. Next, the operations of the stereoscopic intensity adjustment device 30 with the above structure are described.

### Operations of the Stereoscopic Intensity Adjustment Device According to Embodiment 3

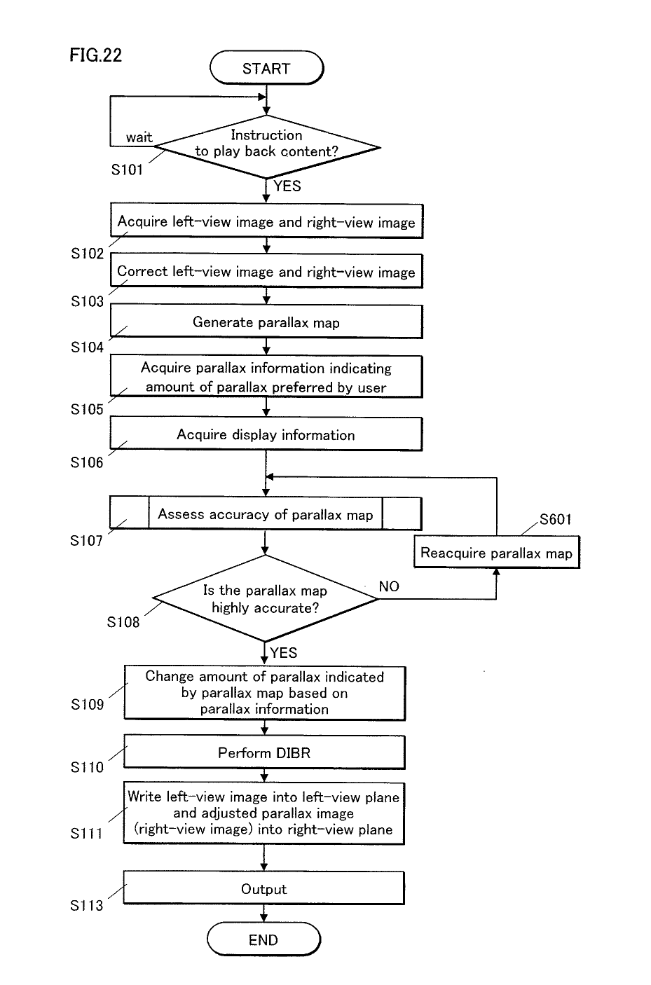

FIG. 22 is a flowchart illustrating the flow of stereoscopic intensity adjustment by the stereoscopic intensity adjustment device 30. Processing steps that are the same as the stereoscopic intensity adjustment according to Embodiment 1 are provided with the same labels, and a description thereof is omitted.

As illustrated in FIG. 22, step S601 differs from the stereoscopic intensity adjustment according to Embodiment 1.

After assessment of accuracy of the parallax map in step S107, it is determined in step S108 whether the parallax map is highly accurate. When the parallax map is assessed as having low accuracy (step S108, NO), the parallax map acquisition unit 1600 requests that the parallax map generation engine 1700 generate a parallax map with a different method than the previous method for generating the parallax map. The parallax map generation engine 1700 regenerates the parallax map in response to the request from the parallax map acquisition unit 1600 (step 601).

After regeneration of the parallax map in step 601, the accuracy of the regenerated parallax map is assessed in step S107.

In the present embodiment, as described above, the parallax map is reacquired when the parallax map has poor accuracy, using a different method than the previous method by which the parallax map is generated. This provides an increase in the accuracy of the parallax map and allows for provision to the user of high-quality content playback.

### Embodiment 4

In Embodiment 4, the structure of a stereoscopic intensity adjustment device that allows for adjustment of the stereoscopic intensity of a stereoscopic video stream is described.

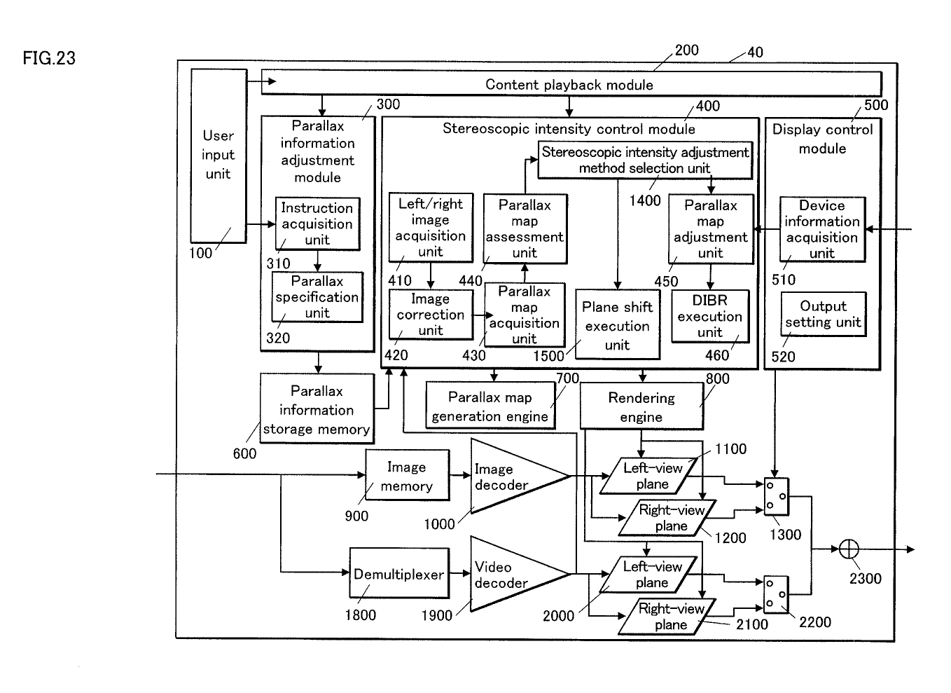

FIG. 23 is a block diagram illustrating an example of the structure of a stereoscopic intensity adjustment device 40 according to Embodiment 4.

As shown in FIG. 23, the stereoscopic intensity adjustment device 40 includes a user input unit 100, a content playback module 200, a parallax information adjustment module 300, a stereoscopic intensity control module 400, a display control module 500, a parallax information storage memory 600, a parallax map generation engine 700, a rendering engine 800, an image memory 900, an image decoder 1000, a left-view plane 1100, a right-view plane 1200, an output switch 1300, a demultiplexer 1800, a video decoder 1900, a left-view plane 2000, a right-view plane 2100, an output switch 2200, and an adder 2300. The parallax information adjustment module 300 includes an instruction acquisition unit 310 and a parallax specification unit 320. The stereoscopic intensity control module 400 includes a left/right image acquisition unit 410, an image correction unit 420, a parallax map acquisition unit 430, a parallax map assessment unit 440, a stereoscopic intensity adjustment method selection unit 1400, a parallax map adjustment unit 450, a DIBR execution unit 460, and a plane shift execution unit 1500. The display control module 500 includes a device information acquisition unit 510 and an output setting unit 520. Components that are the same as the stereoscopic intensity adjustment device 10 according to Embodiment 1 are provided with the same labels, and a description thereof is omitted. Below, structural differences from the stereoscopic intensity adjustment device 10 are described.

### Demultiplexer 1800

The demultiplexer 1800 demultiplexer a transport stream to obtain video frames constituting GOPs and to obtain audio frames. The demultiplexer 1800 outputs the video frames to the video decoder 1900 and outputs the audio frames to the audio decoder (not shown in the figures).

Demultiplexing by the demultiplexer 1800 includes processing to convert TS packets into PES packets. The demultiplexer 1800 also switches between 3D processing and 2D processing.

A parallax map may be included in the video stream separated by the demultiplexer 1800. In this case, the parallax map acquisition unit 430 acquires the parallax map separated by the demultiplexer 1800.

### Video Decoder 1900

The video decoder 1900 decodes the video frames output by the demultiplexer 1800 and writes uncompressed pictures into the left-view plane 2000 and the right-view plane 2100. When stereoscopic intensity is adjusted, the video decoder 1900 transmits the decoded, uncompressed pictures to the left/right image acquisition unit 410.

### Left-View Plane 2000, Right-View Plane 2100

The left-view plane 2000 has a function to store the left-view image output by the video decoder 1900 or the image for which the stereoscopic intensity control module 400 has adjusted the stereoscopic intensity. The right-view plane 2100 has a function to store the right-view image output by the video decoder 1900 or the image for which the stereoscopic intensity control module 400 has adjusted the stereoscopic intensity.

### Output Switch 2200

The output switch 2200 has a function to switch output of the information stored in the left-view plane 2000 and the right-view plane 2100 in accordance with the setting by the output unit 520.

### Adder 2300

The adder 2300 has a function to combine picture data output by the output switch 1300 and the output switch 2200 and output the combined picture data.

Note that when the adder 2300 overlays the stereoscopic images written in the left-view plane 1100 and the right-view plane 1200 or stereoscopic animation on a stereoscopic video stream, the result will appear awkward to the viewer if the stereoscopic images or the stereoscopic animation are buried within or project too far forward from a video stream whose stereoscopic intensity has been adjusted. Therefore, when the stereoscopic intensity of the stereoscopic video stream is adjusted, stereoscopic intensity also needs to be adjusted for the stereoscopic images written in the left-view plane 1100 and the right-view plane 1200 or for the stereoscopic animation.

The above structure allows for adjustment of the stereoscopic intensity of the stereoscopic video stream.

### Modifications

While the present invention has been described according to the above embodiments, the present invention is in no way limited to these embodiments. The present invention also includes cases such as the following.

(a) The present invention may be an application execution method as disclosed by the processing steps described in the embodiments. The present invention may also be a computer program that includes program code causing a computer to perform the above processing steps.

(b) The present invention may also be implemented as an LSI that controls the 3D glasses or the stereoscopic image processing device described in the above embodiments. Such an LSI can be implemented by integrating the functional blocks in the above embodiments, such as a parallax map assessment unit, a parallax map adjustment unit, a stereoscopic intensity adjustment method selection unit, and the like. These functional blocks may be individually integrated as separate chips, or part or all of the functional blocks may be integrated into one chip.

While referred to here as an LSI, depending on the degree of integration, the terms IC, system LSI, super LSI, or ultra LSI are also used.

The method of integration is not limited to LSI, and a dedicated communication circuit or a general-purpose processor may be used. A Field Programmable Gate Array (FPGA), which is an LSI that can be programmed after manufacture, or a reconfigurable processor, which is an LSI whose connections between internal circuit cells and settings for each circuit cell can be reconfigured, may be used.

Additionally, if technology for integrated circuits that replaces LSIs emerges, owing to advances in semiconductor technology or to another derivative technology, the integration of functional blocks and components may naturally be accomplished using such technology. Among such technology, the application of biotechnology or the like is possible.

(c) A control program composed of program code, in machine language or a high-level language, for causing a processor and circuits connected to the processor to execute the parallax map assessment unit, the parallax map adjustment unit, the stereoscopic intensity adjustment method selection unit, and the like described in the above embodiments may be recorded on recording media or circulated and distributed over a variety of communications channels or the like. Such recording media include IC cards, hard disks, optical discs, flexible disks, ROM, flash memory, and the like. The control program that is circulated and distributed is used by being stored on a processor-readable memory or the like. The functions indicated in the embodiments are achieved by the processor executing the control program. Note that instead of directly executing the control program, the processor may compile the control program before execution or execute the control program with an interpreter.

(d) The form of use of the stereoscopic intensity adjustment device described above is only an example of a form of use. The form of use is not limited to the above example.

Another form of use is for the playback device 1 and the display device 4 to be connected with the photography device such as a stereo camera by a cable (such as HDMI connection, USB connection, LAN connection, or the like) or a wireless connection (such as a wireless LAN connection). The playback device 1 and the display device 4 adjust the stereoscopic intensity of the stereoscopic video images photographed by the photography device and then play back and display the adjusted images.

Alternatively, the playback device 1 and the display device 4 may download a video stream that includes stereoscopic video images from a server over a network, read the stereoscopic video images from the downloaded video stream, adjust the stereoscopic intensity of the stereoscopic video images, and then play back and display the adjusted images.

Another possible structure is for a mobile terminal having a display screen to be provided with the stereoscopic adjustment device of the present embodiment. For example, the playback device 1 and the mobile terminal are connected by cable or a wireless connection, and the video stream recorded on a BD-ROM loaded into the playback device 1 is recorded onto memory provided in the mobile terminal or a removable medium loaded into the mobile terminal. The mobile terminal reads the stereoscopic video images included in the recorded video stream, adjusts the stereoscopic intensity thereof, and displays the adjusted images on the display screen of the mobile terminal.

Alternatively, a video stream including stereoscopic video images may be downloaded from a server over a network and recorded onto memory provided in the mobile terminal or a removable medium loaded into the mobile terminal. The mobile terminal then reads the stereoscopic video images included in the recorded video stream. After adjusting the stereoscopic intensity of the stereoscopic video images, the mobile terminal displays the images with adjusted stereoscopic intensity on the display screen of the mobile terminal.

This structure allows for display of stereoscopic video images after adjusting the stereoscopic intensity to correspond to the display screen of the mobile terminal even, for example, when the stereoscopic video images were not intended for display on a display screen as small as that of the mobile terminal.

The stereoscopic intensity adjustment device described in the above embodiments may also be mounted in a device other than the playback device 1 or the display device 4. For example, the stereoscopic intensity adjustment device may be mounted in a mobile terminal, a PC server, a photography device such as a stereo camera, or the like.

The stereoscopic intensity adjustment device described in the above embodiments may be mounted on any device that is connected so as to allow for acquisition of the stereoscopic video images to be displayed, and that is connected so that, after adjusting the stereoscopic intensity of acquired stereoscopic video images, the device can transmit the adjusted stereoscopic video images to a device having a display screen.

(e) During the DIBR in the above embodiments, the stereoscopic intensity is adjusted by shifting each pixel in the left-view image to regenerate the right-view image, but the present invention is not limited in this way. For example, DIBR may be processing to regenerate the left-view image by shifting each pixel in the right-view image. Alternatively, DIBR may be processing to regenerate both the left-view image and the right-view image by shifting both of these images.

(f) In the above embodiments, as an example of changing the amount of parallax indicated by the parallax map to be appropriate for a display based on the size of the display on which the stereoscopic video images are shown, the following cases are described: (1) changing the amount of parallax so that the amount by which an image projects or recedes with respect to the display is based on a parallax angle of one degree, and (2) changing the amount of parallax so that the ratio between the distance from the viewing position to the display and the maximum amount by which images project or recede becomes a predetermined fixed value. The present invention is not, however, limited to these cases.

For example, if the display size is at least a predetermined size, the amount of parallax in the parallax map may be changed so that the amount by which stereoscopic video images project or recede with respect to the size of the display is based on a predetermined parallax angle (for example, one degree). If the display size is equal to or less than a predetermined size, the amount of parallax in the parallax map may be changed so that the amount by which stereoscopic video images project or recede with respect to the size of the display is based on an angle that is at least a predetermined parallax angle (for example, at least one degree) and within a parallax angle at the limit for stereoscopic integration.

When the size of the screen displaying the stereoscopic video images is large, changing the amount of parallax in the above way prevents an increase in the amount of parallax from causing the stereoscopic intensity to exceed a predetermined parallax angle, which would lead to visual fatigue or a sense of awkwardness. Furthermore, when the size of the screen displaying the stereoscopic video images is small, this prevents a decrease in the amount of parallax from causing the left-view image in the right-view image to be recognized as separate images, which would make stereoscopic integration difficult.

(g) In the above embodiments, the distance from the viewing position to the display has been described as being calculated by multiplying the height H of the display by three, but the present invention is not limited in this way. For example, a distance sensor, such as a Time Of Flight (TOF) sensor, may be used to calculate the distance from the viewing position to the display.

(h) In the above embodiments, the base-line length (interpupillary distance) is 6.5 cm, the average value for an adult male, but the present invention is not limited in this way. For example, it may be determined whether the viewer is an adult or a child, and whether the viewer is male or female, and the base-line length may be set based on the result of this determination.

(i) In the above embodiments, the parallax map is an image indicating the amount of parallax with the distance in the depth direction as one of 256 levels of brightness, from 0 to 255, but the present invention is not limited in this way. The parallax map need only be data that stores the value of the parallax, or the distance in the depth direction, for each pixel in the left-view image and the right-view image. For example, the parallax map may be an image representing brightness as one of 128 levels, from 0 to 127.

(j) In the above embodiments, the left-view images and right-view images for which stereoscopic intensity has been adjusted may be archived, and when a command to play back the same image again is issued, the stereoscopic intensity may be adjusted based on the archived left-view images and right-view images.

(l) The target of stereoscopic intensity adjustment in the above embodiments is not limited to stereoscopic video images, but may also be performed on stereoscopic images that do not constitute video.

(m) In the above embodiments, generation of images from two views, a left-view image and a right-view image, is described, but the present invention is not limited in this way. A multi-view image from two or more views may be generated.

(n) In the above embodiments, a system is described in which stereoscopic video images are viewed using 3D glasses, but alternatively, the system may be a naked-eye 3D system that does not require 3D glasses.

(o) The above embodiments and modifications may be combined with one another.

### INDUSTRIAL APPLICABILITY

The stereoscopic intensity adjustment device of the present invention may, for example, be used for viewing of stereoscopic video images in a home theater system.

### REFERENCE SIGNS LIST

1 playback device
2 recording medium
3 operating device
4 display device
5 3D glasses
10, 20, 30, 40 stereoscopic intensity adjustment device
100 user input unit
200 content playback module
300 parallax information adjustment module
310 instruction acquisition unit
320 parallax specification unit
400 stereoscopic intensity control module
410 left/right image acquisition unit
420 image correction unit
430 parallax map acquisition unit
440 parallax map assessment unit
450 parallax map adjustment unit
460 DIBR execution unit
500 display control module
510 device information acquisition unit
520 output setting unit
600 parallax information storage memory
700 parallax map generation engine
800 rendering engine
900 image memory
1000 image decoder
1100 left-view plane
1200 right-view plane
1300 output switch
1400 stereoscopic intensity adjustment method selection unit
1500 plane shift execution unit
1600 parallax map acquisition unit
1700 parallax map generation engine
1800 demultiplexer
1900 video decoder
2000 left-view plane
2100 right-view plane
2200 output switch
2300 adder

1. A stereoscopic intensity adjustment device for adjusting stereoscopic intensity of stereoscopic video images, comprising:
a parallax map acquisition unit configured to acquire a parallax map indicating a parallax value for each pixel in a set of main-view data and sub-view data constituting the stereoscopic video images;
an accuracy determination unit configured to determine accuracy of the parallax map; and
a stereoscopic intensity adjustment unit configured to adjust the stereoscopic intensity of the stereoscopic video images, wherein
in accordance with the accuracy of the parallax map, the stereoscopic intensity adjustment unit selectively performs one of pixel shifting and plane shifting, the pixel shifting referencing the parallax map.

2. The stereoscopic intensity adjustment device of claim 1, wherein
the accuracy determination unit determines the accuracy of the parallax map with reference to the stereoscopic intensity of the stereoscopic video images, the stereoscopic intensity being yielded by the parallax values indicated in the parallax map, and
the stereoscopic intensity adjustment unit selects pixel shifting with reference to the parallax map when the stereoscopic intensity of the stereoscopic video images is at least a first predetermined intensity and selects plane shifting when the stereoscopic intensity of the stereoscopic video images is at most a second predetermined intensity.

3. The stereoscopic intensity adjustment device of claim 2, wherein
the stereoscopic intensity of the stereoscopic video images is based on parallax angle, and
the accuracy determination unit determines the accuracy of the parallax map by calculating the parallax angle with reference to the parallax values indicated in the parallax map and comparing the calculated parallax angle with a predetermined threshold.

4. The stereoscopic intensity adjustment device of claim 1, wherein
the parallax map acquisition unit acquires the parallax map by searching for corresponding points between the main-view data and the sub-view data,
the accuracy determination unit determines the accuracy of the parallax map with reference to an amount of error occurring when the parallax map acquisition unit searches for the corresponding points, and
the stereoscopic intensity adjustment unit selects pixel shifting with reference to the parallax map when the accuracy throughout the parallax map is at least a first predetermined accuracy and selects plane shifting when the accuracy throughout the parallax map is at most a second predetermined accuracy.

5. The stereoscopic intensity adjustment device of claim 4, wherein
the amount of error is the number of pixels for which no corresponding point is detected and of pixels for which a plurality of candidate corresponding points are detected during the search for corresponding points, and
the accuracy determination unit determines the accuracy of the parallax map by comparing the number of pixels for which no corresponding point is detected and of pixels for which a plurality of candidate corresponding points are detected during the search for corresponding points with a predetermined threshold.

6. The stereoscopic intensity adjustment device of claim 1, further comprising:
a screen size acquisition unit configured to acquire a size of a screen on which the stereoscopic video images are displayed, wherein
during the pixel shifting, the stereoscopic intensity adjustment unit
changes an amount of parallax indicated by the parallax map with reference to the size of the screen and the accuracy of the parallax map, and
regenerates the sub-view data by shifting coordinates of each pixel in the main-view data by a number of pixels corresponding to the changed amount of parallax.

7. The stereoscopic intensity adjustment device of claim 6, wherein
the accuracy determination unit determines the accuracy of a foreground region and of a background region in the parallax map, and
during the pixel shifting, the stereoscopic intensity adjustment unit invalidates the amount of parallax in the background region of the parallax map when the accuracy of the background region of the parallax map is less than a predetermined accuracy.

8. The stereoscopic intensity adjustment device of claim 6, wherein
the accuracy determination unit determines the accuracy of a foreground region and a background region in the parallax map, and
during the pixel shifting, the stereoscopic intensity adjustment unit averages the amount of parallax in the foreground region of the parallax map when the accuracy of the foreground region of the parallax map is less than a predetermined accuracy.

9. The stereoscopic intensity adjustment device of claim 8, wherein
during the pixel shifting, the stereoscopic intensity adjustment unit extracts an outline of an object included in the foreground region of the parallax map and averages the amount of parallax in the foreground region of the parallax map when accuracy of extraction of the outline is at least a predetermined accuracy.

10. The stereoscopic intensity adjustment device of claim 6, wherein
the accuracy determination unit determines the accuracy of the parallax map with reference to the stereoscopic intensity of the stereoscopic video images, the stereoscopic intensity being yielded by the parallax values indicated in the parallax map, and
during the pixel shifting, the stereoscopic intensity adjustment unit reduces the amount of parallax indicated by the parallax map when the stereoscopic intensity of the stereoscopic video images is at least a predetermined intensity.

11. The stereoscopic intensity adjustment device of claim 10, wherein
during the pixel shifting, the stereoscopic intensity adjustment unit changes the amount of parallax indicated by the parallax map so that an amount by which the stereoscopic video images project or recede with respect to the size of the screen is based on a predetermined parallax angle.

12. The stereoscopic intensity adjustment device of claim 6, wherein
during the pixel shifting, the stereoscopic intensity adjustment unit changes the amount of parallax indicated by the parallax map so that a ratio between a viewing distance and an amount by which the stereoscopic video images project or recede becomes a predetermined fixed value.

13. The stereoscopic intensity adjustment device of claim 6, wherein
during the pixel shifting,
when the size of the screen is at least a first predetermined size, the stereoscopic intensity adjustment unit changes the amount of parallax indicated by the parallax map so that an amount by which the stereoscopic video images project or recede with respect to the size of the screen is based on a predetermined parallax angle, and
when the size of the screen is at most a second predetermined size, the stereoscopic intensity adjustment unit changes the amount of parallax indicated by the parallax map so that an amount by which the stereoscopic video images project or recede with respect to the size of the screen is based on an angle that is at least a predetermined parallax angle and is within a parallax angle indicating a limit for stereoscopic integration.

14. The stereoscopic intensity adjustment device of claim 1, further comprising:
planes including a left-view plane and a right-view plane; and
a rendering engine configured to write video data in the planes, wherein
when the accuracy throughout the parallax map is at least a first predetermined accuracy, the rendering engine writes main-view data and sub-view data after the adjustment of stereoscopic intensity into the planes, and
when the accuracy throughout the parallax map is at most a second predetermined accuracy, the rendering engine writes the main-view data before the adjustment of stereoscopic intensity into both the left-view plane and the right-view plane.

15. The stereoscopic intensity adjustment device of claim 1, wherein
the parallax map acquisition unit reacquires the parallax map when the accuracy of the parallax map is less than a predetermined accuracy.

16. The stereoscopic intensity adjustment device of claim 15, wherein
the parallax map acquisition unit reacquires the parallax map using a different method than during a previous acquisition of the parallax map.

17. A stereoscopic intensity adjustment method for adjusting stereoscopic intensity of stereoscopic video images, comprising the steps of:
acquiring a parallax map indicating a parallax value for each pixel in a set of main-view data and sub-view data constituting the stereoscopic video images;
determining accuracy of the parallax map; and
adjusting the stereoscopic intensity of the stereoscopic video images, wherein
during the step of adjusting the stereoscopic intensity, in accordance with the accuracy of the parallax map, one of pixel shifting and plane shifting is selectively performed, the pixel shifting referencing the parallax map.

18. A program for causing a computer to perform stereoscopic intensity adjustment to adjust stereoscopic intensity of stereoscopic video images, the program causing the computer to perform the steps of:
acquiring a parallax map indicating a parallax value for each pixel in a set of main-view data and sub-view data constituting the stereoscopic video images;
determining accuracy of the parallax map; and
adjusting the stereoscopic intensity of the stereoscopic video images, wherein
during the step of adjusting the stereoscopic intensity, in accordance with the accuracy of the parallax map, one of pixel shifting and plane shifting is selectively performed, the pixel shifting referencing the parallax map.

19. An integrated circuit for stereoscopic intensity adjustment to adjust stereoscopic intensity of stereoscopic video images, comprising:
a parallax map acquisition unit configured to acquire a parallax map indicating a parallax value for each pixel in a set of main-view data and sub-view data constituting the stereoscopic video images;
an accuracy determination unit configured to determine accuracy of the parallax map; and
a stereoscopic intensity adjustment unit configured to adjust the stereoscopic intensity of the stereoscopic video images, wherein
in accordance with the accuracy of the parallax map, the stereoscopic intensity adjustment unit selectively performs one of pixel shifting and plane shifting, the pixel shifting referencing the parallax map.

20. A recording medium having recorded thereon a program for causing a computer to perform stereoscopic intensity adjustment to adjust stereoscopic intensity of stereoscopic video images,
the program causing the computer to perform the steps of:
acquiring a parallax map indicating a parallax value for each pixel in a set of main-view data and sub-view data constituting the stereoscopic video images;
determining accuracy of the parallax map; and
adjusting the stereoscopic intensity of the stereoscopic video images, wherein
during the step of adjusting the stereoscopic intensity, in accordance with the accuracy of the parallax map, one of pixel shifting and plane shifting is selectively performed, the pixel shifting referencing the parallax map.
